(19) United States
(12) Patent Application Publication
(10) Pub. No.: US 2025/0290375 A1
(43) Pub. Date: Sep. 18, 2025

(54) LIGHT-SHIELDING FABRIC CAPABLE OF IMPLEMENTING TWO COLORS OR FUNCTIONS AND CURTAIN-TYPE VERTICAL BLIND USING THE SAME

(71) Applicant: WINPLUS CO., LTD., Chungcheongbuk-do (KR)

(72) Inventor: Taewoong BYEON, Daejeon (KR)

(21) Appl. No.: 18/808,095

(22) Filed: Aug. 19, 2024

(30) Foreign Application Priority Data
Mar. 12, 2024 (KR) 10-2024-0034524
Mar. 14, 2024 (KR) 10-2024-0035782
May 27, 2024 (KR) 10-2024-0068523
Jun. 27, 2024 (KR) 10-2024-0084192

(51) Int. Cl. E06B 9/36; D03D 1/00

(52) U.S. Cl. CPC E06B 9/36; D03D 1/007; D10B 2401/22; D10B 2503/03

(57) ABSTRACT

A light-shielding fabric for a curtain-type vertical blind may include a single light-transmitting portion (130) capable of transmitting light, a first light-shielding portion (110) disposed at one side of the light-transmitting portion (130) and attached or coupled to the light-transmitting portion, and a second light-shielding portion (120) disposed at the other side of the light-transmitting portion (130) and attached or coupled to the light-transmitting portion, in which a front surface (110a) of the first light-shielding portion (110) and a rear surface (120b) of the second light-shielding portion (120) have a first color (A), in which a rear surface (110b) of the first light-shielding portion (110) and a front surface (120a) of the second light-shielding portion (120) have a second color (B), and in which the first color (A) is different from the second color (B).

### CROSS-REFERENCE TO RELATED APPLICATIONS

This application claims the priority of Korean Patent Application No. 10-2024-0034524 filed on Mar. 12, 2024, Korean Patent Application No. 10-2024-0035782 filed on Mar. 14, 2024, Korean Patent Application No. 10-2024-0068523 filed on May 27, 2024, and Korean Patent Application No. 10-2024-0084192 filed on Jun. 27, 2024, in the Korean Intellectual Property Office, the disclosure of which is incorporated herein by reference.

### BACKGROUND

### Field

The present disclosure relates to a light-shielding fabric capable of implementing two colors or two functions and a curtain-type vertical blind using the same, and more particularly, to a light-shielding fabric capable of selecting and implementing one color or function from two colors or functions depending on rotation directions of light-shielding portions, a curtain-type vertical blind using the same, and a method of manufacturing the same.

In addition, the present disclosure relates to a light-shielding fabric, which is configured such that adjacent light-shielding portions are brought into contact with each other by a magnet or magnetic material so that the adjacent light-shielding portions are not spaced apart from each other in a curtain-type vertical blind, and a curtain-type vertical blind using the same.

### Description of the Related Art

In general, curtains or blinds are installed on windows or doorways of buildings and used to block sunlight, block views from the outside, insulate sounds, and provide protection against cold. In addition to this practicality, the curtains or blinds are used as important elements for interior decoration to improve interior aesthetic appearances in accordance with color schemes that may be matched with interior walls or glass.

For example, depending on the shapes of the curtains or blinds, the curtains or blinds may be classified into a general curtain that is unfolded or folded from a center toward two opposite sides, a vertical blind that is divided into a plurality of vertically formed pieces and capable of adjusting inclination angles of the pieces, a roll screen blind in which one or two blind sheets are wound around or unwound from a rotating winding bar, and a Roman shade curtain in which a curtain sheet is folded upward or downward by a winding operation of a cord for adjusting a length.

FIG. 1 illustrates a roll screen blind in the related art. The roll screen blind is operated to unwind a roll screen downward or wind the roll screen upward by rotating a winding bar by using an operating wire installed at one side of the winding bar. A front surface of the roll screen is directed toward an indoor side, and a rear surface of the roll screen may be directed toward an outdoor side.

FIG. 2 illustrates a vertical blind in the related art. The vertical blind is configured such that a plurality of vertical pieces is moved to one side and collected to open openings of a window or doorway of a building, and the plurality of vertical pieces is moved to the other side and unfolded to expose external views and implement ventilation between the pieces. The amount of light or ventilation may be adjusted by adjusting angles of the pieces in the state in which the plurality of pieces is unfolded. In case that the complete light shading or wind protection is required, the angles of the pieces may be adjusted so that the pieces are arranged in a row in a horizontal direction. However, the vertical blind in the related art, which is illustrated in FIG. 2, has a problem in that the vertical blind is not suitable for privacy protection because the vertical blind has the plurality of vertically formed blind pieces and the indoor side may be observed between the blind pieces.

In order to solve this problem, as illustrated in FIG. 3, WO 2016/114516 discloses a light-shielding fabric for a curtain-type vertical blind in which a light-transmitting portion and a light-blocking portion are integrally woven to provide a light shading function, a privacy protection function, a decoration effect, and a thermal insulation effect. A central portion of the light-shielding fabric illustrated in FIG. 3 is configured as a light-transmitting portion in the form of a net or mesh capable of transmitting light, and two opposite sides of the central portion are configured as light-shielding portions capable of blocking light.

In case that the curtain-type vertical blind is manufactured by using the light-shielding fabric illustrated in FIG. 3, the light-shielding fabric is cut into sections having predetermined lengths, and then upper ends of the light-shielding fabric sections are fixed in a state in which light-shielding portions of the adjacent light-shielding fabric sections are disposed to be in contact with one another, as illustrated in FIG. 4. The curtain-type vertical blind disclosed in WO 2016/114516 illustrated in FIG. 5 may be manufactured by the above-mentioned method.

### SUMMARY

However, the light-shielding portion of the light-shielding fabric of the curtain-type vertical blind in the related art disclosed in WO 2016/114516 has a single color or material, which makes it difficult to establish various indoor appearance. In addition, for example, in case that a user prefers a curtain-type vertical blind with a gorgeous color such as a pink or sky-blue color, the pink or sky-blue color of the light-shielding portion of the vertical blind is exposed to the outside in an intact manner, which may spoil overall views of apartments in collective buildings such as the apartment and cause disharmony or unpleasantness to other persons.

In addition, in case that the angles of the light-shielding portions of the blind are adjusted to arrange the light-shielding portions in a row in the horizontal direction when complete light shading or wind protection is required, it is necessary to transfer as little solar heat to the interior as possible in the summer season and to transfer as much solar heat to the interior as possible in the winter season. However, in the case of the curtain-type vertical blind in the related art, there is a problem in that it is impossible to adjust the solar heat transfer characteristics for each season.

In addition, in case that one of the two light-shielding portions is fixed without being arranged vertically at the time of fixing the adjacent light-shielding fabrics in the curtain-type vertical blind in the related art, there may occur a problem in that the adjacent light-shielding portions are spaced apart from each other or the blinds cannot be appropriately aligned, and sunlight enters from the outside.

In addition, because the light-shielding portions are fixed only at the upper ends of the adjacent light-shielding fabrics in the curtain-type vertical blind in the related art, there may occur a problem in that the adjacent light-shielding fabrics are not entirely tightly attached to each other, but are partially spaced apart from one another. In this case, there may occur a problem in that in a state in which the blind is unfolded widely so that the light-transmitting portion is exposed to the front side, light is transmitted through the light-shielding portions, sunlight enters from the outside through a gap between the light-shielding portions, and the interior is visible from the outside.

The present disclosure has been made in an effort to solve the above-mentioned problem in the related art, and an object of the present disclosure is to provide a light-shielding fabric for a curtain-type vertical blind, which is capable of selecting and implementing one color from two colors depending on rotation directions of light-shielding portions to establish various indoor appearances without causing disharmony or unpleasantness to other persons, a curtain-type vertical blind using the same, and a method of manufacturing the curtain-type vertical blind.

Another object of the present disclosure is to provide a light-shielding fabric for a curtain-type vertical blind, which is capable of adjusting solar heat transfer characteristics for each season, a curtain-type vertical blind using the same, and a method of manufacturing the curtain-type vertical blind.

Still another object of the present disclosure is to provide a curtain-type vertical blind, which has one light-transmitting portion and first and second light-shielding portions respectively disposed at one side and the other side of the light-transmitting portion and attached or coupled to the light-transmitting portion, in which the adhesion between the adjacent light-shielding portions is improved to prevent the light-shielding portions from being spaced apart from one another, prevent sunlight from entering between the adjacent light-shielding portions, and prevent the interior from being visible from the outside.

Yet another object of the present disclosure is to provide a curtain-type vertical blind, which has one light-transmitting portion and first and second light-shielding portions respectively disposed at one side and the other side of the light-transmitting portion and attached or coupled to the light-transmitting portion, in which the curtain-type vertical blind has a structure in which a magnet or magnetic material is installed on the light-shielding portion to improve the adhesion between the adjacent light-shielding portions, thereby preventing the light-shielding portions from being spaced apart from one another.

However, these objects of the present disclosure are illustrative, and the scope of the present disclosure is not limited by the objects.

According to a first embodiment of the present disclosure, a light-shielding fabric for a curtain-type vertical blind may include: a single light-transmitting portion capable of transmitting light; a first light-shielding portion disposed at one side of the light-transmitting portion and attached or coupled to the light-transmitting portion; and a second light-shielding portion disposed at the other side of the light-transmitting portion and attached or coupled to the light-transmitting portion, in which a front surface of the first light-shielding portion and a rear surface of the second light-shielding portion have a first color, in which a rear surface of the first light-shielding portion and a front surface of the second light-shielding portion have a second color, and in which the first color is different from the second color.

In the light-shielding fabric for a curtain-type vertical blind according to the first embodiment of the present disclosure, the light-transmitting portion may be arranged to cover the entire front or rear surfaces of the first light-shielding portion and the second light-shielding portion.

In addition, according to the second embodiment of the present disclosure, a light-shielding fabric for a curtain-type vertical blind may include: a single light-transmitting portion capable of transmitting light; a first light-shielding portion disposed at one side of the light-transmitting portion and attached or coupled to the light-transmitting portion; and a second light-shielding portion disposed at the other side of the light-transmitting portion and attached or coupled to the light-transmitting portion, in which a front surface of the first light-shielding portion has a first color, and in which a front surface of the second light-shielding portion has a second color different from the first color.

In the light-shielding fabric for a curtain-type vertical blind according to the second embodiment of the present disclosure, the light-transmitting portion may be arranged to cover the entire front or rear surfaces of the first light-shielding portion and the second light-shielding portion.

In the light-shielding fabric for a curtain-type vertical blind according to the second embodiment of the present disclosure, a rear surface of the first light-shielding portion may have the first color, and a rear surface of the second light-shielding portion may have the second color.

In addition, in the light-shielding fabric for a curtain-type vertical blind according to a modified example of the second embodiment of the present disclosure, the rear surface of the first light-shielding portion and the rear surface of the second light-shielding portion may have the same color.

Meanwhile, according to the modified example of the first and second embodiments of the present disclosure, the light-shielding fabric for a curtain-type vertical blind may include a single light-transmitting portion capable of transmitting light; a first light-shielding portion disposed at one side of the light-transmitting portion and attached or coupled to the light-transmitting portion; and a second light-shielding portion disposed at the other side of the light-transmitting portion and attached or coupled to the light-transmitting portion, in which the light-transmitting portion may be disposed to cover the entire front or rear surfaces of the first and second light-shielding portions, and the light-transmitting portion may be attached or coupled to the first and second light-shielding portions from the point exceeding half the width of the front or rear surface of each of the first and second light-shielding portions to the outer edge of each of the first and second light-shielding portions, and in which the front surface of the first light-shielding portion, the rear surface of the first light-shielding portion, the front surface of the second light-shielding portion, and the rear surface of the second light-shielding portion may have the same color.

In addition, according to the third embodiment of the present disclosure, a light-shielding fabric for a curtain-type vertical blind may include: a single light-transmitting portion capable of transmitting light; a first light-shielding portion disposed at one side of the light-transmitting portion and attached or coupled to the light-transmitting portion; and a second light-shielding portion disposed at the other side of the light-transmitting portion and attached or coupled to the light-transmitting portion, in which a light reflective layer is formed on a front surface of the first light-shielding portion, and a light absorption layer is formed on a front surface of the second light-shielding portion.

In the light-shielding fabric for a curtain-type vertical blind according to the third embodiment of the present disclosure, the light-transmitting portion may be arranged to cover the entire front or rear surfaces of the first light-shielding portion and the second light-shielding portion.

In the light-shielding fabric for a curtain-type vertical blind according to the first to third embodiments of the present disclosure, the light-transmitting portion and the first and second light-shielding portions may be integrally woven.

In addition, in the light-shielding fabric for a curtain-type vertical blind according to the first to third embodiments of the present disclosure, the light-transmitting portion may be attached or coupled to the first and second light-shielding portions 110 and 120 from a point exceeding half a width of the front or rear surface of each of the first and second light-shielding portions to an outer edge of the first and second light-shielding portions.

In the light-shielding fabric for a curtain-type vertical blind according to the first to third embodiments of the present disclosure, the first and second light-shielding portions and the light-transmitting portion may be attached or coupled by a hot-melt adhesive or bonding agent.

In addition, in the light-shielding fabric for a curtain-type vertical blind according to the first to third embodiments of the present disclosure, the first and second light-shielding portions and the light-transmitting portion may be attached or coupled by sewing or ultrasonic welding.

In addition, the embodiment of the present disclosure provides a curtain-type vertical blind manufactured by using the above-mentioned light-shielding fabric.

Meanwhile, according to a fourth embodiment of the present disclosure, a method of manufacturing a curtain-type vertical blind by using the light-shielding fabric may include: cutting the light-shielding fabric into a plurality of light-shielding fabrics sections having a predetermined length; disposing the plurality of light-shielding fabrics sections, which are cut in the cutting step, such that the adjacent light-shielding fabric sections are disposed so that the rear surface of the first light-shielding portion of one section and the rear surface of the second light-shielding portion of another section are in contact with each other; and fixing the plurality of light-shielding fabrics sections, which are disposed in the disposing step, such that the adjacent light-shielding fabric sections are fixed so that an upper end of the first light-shielding portion of one section and an upper end of the second light-shielding portion of another section are fixed together, in which when the plurality of light-shielding fabrics sections are rotated in different directions, the front surface of the first light-shielding portion of one section of the plurality of light-shielding fabrics sections and the front surface of the second light-shielding portion of another section may be exposed to the outside, respectively. That is, the front surface of the first light-shielding portion of one section and the front surface of the second light-shielding portion of another section may be blind surfaces visible from the outside.

In the method of manufacturing the curtain-type vertical blind according to the fourth embodiment of the present disclosure, the separate light-shielding portions may be additionally attached and disposed at outermost sides of left and right sides in the disposing step, respectively.

In addition, in the method of manufacturing a curtain-type vertical blind according to the fourth embodiment of the present disclosure, in the fixing step, one or more through-holes may be formed at the upper end of the first light-shielding portion of one section and the upper end of the second light-shielding portion of another section of the plurality of light-shielding fabric sections, and fixing means may be coupled to the through-holes, such that the upper end of the first light-shielding portion of one section and the upper end of the second light-shielding portion of another section are fixed together.

Meanwhile, the embodiment of the present disclosure provides a curtain-type vertical blind, in which when the first light-shielding portions and the second light-shielding portions of the plurality of light-shielding fabric sections are rotated about a vertical axis in one direction in a state in which the curtain-type vertical blind is unfolded, the front surface of the first light-shielding portions is exposed to an outdoor side to define a blind surface having the first color, and in which when the first light-shielding portions and the second light-shielding portions are rotated in a direction opposite to one direction, the front surface of the second light-shielding portions is exposed to the outdoor side to define a blind surface having the second color.

Meanwhile, in a curtain-type vertical blind manufactured by using the light-shielding fabric for a curtain-type vertical blind according to the third embodiment of the present disclosure and by cutting the light-shielding fabric into a plurality of light-shielding fabric sections having a predetermined length, disposing the adjacent light-shielding fabric sections so that the rear surface of the first light-shielding portion of one section and the rear surface of the second light-shielding portion of another section of the plurality of light-shielding fabric sections are in contact with each other, and fixing together an upper end of the first light-shielding portion of one section and an upper end of the second light-shielding portion of another section, in which when the first light-shielding portions and the second light-shielding portions of the plurality of light-shielding fabric sections are rotated about a vertical axis in one direction in a state in which the curtain-type vertical blind is unfolded, the front surface of the first light-shielding portions is exposed to an outdoor side so that the light reflective layer defines a curtain surface, and in which when the first light-shielding portions and the second light-shielding portions are rotated in a direction opposite to one direction, the front surface of the second light-shielding portions is exposed to the outdoor side so that the light absorption layer defines a curtain surface.

Meanwhile, according to the fifth embodiment of the present disclosure, a light-shielding fabric for a curtain-type vertical blind may include: a single light-transmitting portion capable of transmitting light; a first light-shielding portion disposed at one side of the light-transmitting portion and attached or coupled to the light-transmitting portion; and a second light-shielding portion disposed at the other side of the light-transmitting portion and attached or coupled to the light-transmitting portion, in which a front surface of the first light-shielding portion and a rear surface of the second light-shielding portion have a first color, in which a rear surface of the first light-shielding portion and a front surface of the second light-shielding portion have a second color, and in which the first color is different from the second color, and in which a first magnet is installed on the first light-shielding portion, and a second magnet or magnetic material is installed on the second light-shielding portion.

According to the modified example of the fifth embodiment of the present disclosure, a light-shielding fabric for a curtain-type vertical blind may include: a single light-transmitting portion capable of transmitting light; a first light-shielding portion disposed at one side of the light-transmitting portion and attached or coupled to the light-transmitting portion; and a second light-shielding portion disposed at the other side of the light-transmitting portion and attached or coupled to the light-transmitting portion, in which a front surface of the first light-shielding portion has a first color, in which a front surface of the second light-shielding portion has a second color different from the first color, in which the first color is different from the second color, and in which a first magnet is installed on the first light-shielding portion, and a second magnet or magnetic material is installed on the second light-shielding portion.

In the light-shielding fabric for a curtain-type vertical blind according to the fifth embodiment of the present disclosure and the modified example thereof, the light-transmitting portion may be arranged to cover the entire front or rear surfaces of the first light-shielding portion and the second light-shielding portion.

In addition, in the light-shielding fabric for a curtain-type vertical blind according to the fifth embodiment of the present disclosure and the modified example thereof, the first magnet and the second magnet may be made by aligning or magnetizing magnet powder contained in resin applied onto the first light-shielding portion and the second light-shielding portion.

In addition, in the light-shielding fabric for a curtain-type vertical blind according to the fifth embodiment of the present disclosure and the modified example thereof, the first magnet and the second magnet or magnetic material may be configured by one or more of: i) aligning or magnetizing magnet powder contained in resin applied onto the first light-shielding portion and the second light-shielding portion; ii) installing the first magnet and the second magnet or magnetic material at lower ends of the first light-shielding portion and the second light-shielding portion, respectively; iii) installing the first magnet and the second magnet or magnetic material on the first light-shielding portion and the second light-shielding portion, respectively, at an interval in an upward/downward direction; and iv) installing the first magnet and the second magnet or magnetic material continuously in the upward/downward direction along the first light-shielding portion and the second light-shielding portion, respectively.

In addition, according to another modified example of the fifth embodiment of the present disclosure, a light-shielding fabric for a curtain-type vertical blind may include: a single light-transmitting portion capable of transmitting light; a first light-shielding portion disposed at one side of the light-transmitting portion and attached or coupled to the light-transmitting portion; and a second light-shielding portion disposed at the other side of the light-transmitting portion and attached or coupled to the light-transmitting portion, in which a front surface of the first light-shielding portion and a rear surface of the second light-shielding portion have a first color, in which a rear surface of the first light-shielding portion and a front surface of the second light-shielding portion have a second color, in which the first color is different from the second color, and in which counterweights are installed at lower ends of the first light-shielding portion and the second light-shielding portion, respectively.

In addition, according to the modified example of the fifth embodiment of the present disclosure, a light-shielding fabric for a curtain-type vertical blind may include: a single light-transmitting portion capable of transmitting light; a first light-shielding portion disposed at one side of the light-transmitting portion and attached or coupled to the light-transmitting portion; and a second light-shielding portion disposed at the other side of the light-transmitting portion and attached or coupled to the light-transmitting portion, in which a front surface of the first light-shielding portion has a first color, in which a front surface of the second light-shielding portion has a second color different from the first color, in which the first color is different from the second color, and in which counterweights are installed at lower ends of the first light-shielding portion and the second light-shielding portion, respectively.

According to a sixth embodiment of the present disclosure, a light-shielding fabric for a curtain-type vertical blind may include: a single light-transmitting portion capable of transmitting light; a first light-shielding portion disposed at one side of the light-transmitting portion and attached or coupled to the light-transmitting portion; a second light-shielding portion disposed at the other side of the light-transmitting portion and attached or coupled to the light-transmitting portion; a first magnet installed on the first light-shielding portion; and a second magnet or magnetic material installed on the second light-shielding portion.

In the light-shielding fabric for a curtain-type vertical blind according to the sixth embodiment of the present disclosure, the light-transmitting portion may be arranged to cover the entire front or rear surfaces of the first light-shielding portion and the second light-shielding portion.

In addition, in the light-shielding fabric for a curtain-type vertical blind according to the sixth embodiment of the present disclosure, the first magnet and the second magnet or magnetic material may be configured by one or more of: i) aligning or magnetizing magnet powder contained in resin applied onto the first light-shielding portion and the second light-shielding portion; ii) installing the first magnet and the second magnet or magnetic material at lower ends of the first light-shielding portion and the second light-shielding portion, respectively; iii) installing the first magnet and the second magnet or magnetic material on the first light-shielding portion and the second light-shielding portion, respectively, at an interval in an upward/downward direction; and iv) installing the first magnet and the second magnet or magnetic material continuously in the upward/downward direction along the first light-shielding portion and the second light-shielding portion, respectively.

In the curtain-type vertical blind manufactured by using the light-shielding fabric for the curtain-type vertical blind according to the present disclosure described above, one color may be selected or implemented from the two colors depending on the rotation directions of the light-shielding portions, such that various indoor appearances may be established, and disharmony or unpleasantness may not be caused to other persons.

In addition, when the curtain-type vertical blind is manufactured by using the light-shielding fabric for a curtain-type vertical blind according to the present disclosure, it is possible to obtain an effect of adjusting solar heat transfer characteristics for each season.

In addition, when the curtain-type vertical blind is manufactured by using the light-shielding fabric for a curtain-type vertical blind according to the present disclosure, the light-transmitting portion and the light-shielding portion may be integrated with each other, and the light-transmitting portion may be controlled by the weight of the light-shielding portion, such that straightness may be imparted toward the lower side of the light-transmitting portion, which may prevent the light-transmitting portion from becoming wavy.

In addition, when the curtain-type vertical blind is manufactured by using the light-shielding fabric for a curtain-type vertical blind according to the present disclosure, the closed blinds are not spaced apart from one another, and the shapes of the blinds may be maintained, a gap may not be formed between the blinds to prevent the interior from being visible from the outside and maintain uniform appearances of the blinds.

In addition, when the curtain-type vertical blind is manufactured by using the light-shielding fabric for a curtain-type vertical blind according to the present disclosure, a rotational force may be simultaneously transmitted to the lower side of the blind by the weight of the light-shielding portion when the blind is rotated to adjust the angle of the blind, the lower side of the blind may be rotated in the same way as the upper side of the blind.

In addition, when the curtain-type vertical blind is manufactured by using the light-shielding fabric for a curtain-type vertical blind according to the present disclosure, the adhesion between the adjacent light-shielding portions is remarkably improved, such that the interior is not visible from the outside when the blind is closed.

In addition, when the curtain-type vertical blind is manufactured by using the light-shielding fabric for a curtain-type vertical blind according to the present disclosure, the adhesion between the adjacent light-shielding portions may be remarkably improved, thereby preventing light from being transmitted between the light-shielding portions or preventing a gap from being formed between the light-shielding portions in a state in which the blind is unfolded widely so that the light-transmitting portion is exposed to the front side.

In addition, when the curtain-type vertical blind is manufactured by using the light-shielding fabric for a curtain-type vertical blind according to the present disclosure, the magnet installed at the lower end of the light-shielding fabric serves as a counterweight for sagging and unfolding the light-shielding fabric downward, such that the light-shielding fabrics do not blow in the wind and thus are not misaligned. Further, even though the light-shielding fabrics are misaligned, the lower ends of the light-shielding fabrics are attached to one another by magnetic forces, such that the light-shielding fabrics may be easily restored to original states and aligned.

However, these effects of the present disclosure are illustrative, and the scope of the present disclosure is not limited by the effects.

### BRIEF DESCRIPTION OF THE DRAWINGS

FIG. 1 is a schematic view illustrating a roll screen blind in the related art.

FIG. 2 is a schematic view illustrating a vertical blind in the related art.

FIG. 3 is a schematic view of a light-shielding fabric used to manufacture a curtain-type vertical blind in the related art.

FIG. 4 is a view illustrating a process of manufacturing the curtain-type vertical blind in the related art by using the light-shielding fabric in FIG. 3.

FIG. 5 is a partially enlarged view of the curtain-type vertical blind in the related art manufactured by using the light-shielding fabric in FIG. 3.

FIG. 6 is a view schematically illustrating a light-shielding fabric for a curtain-type vertical blind according to a first embodiment of the present disclosure.

FIG. 7 is a view schematically illustrating a light-shielding fabric for a curtain-type vertical blind according to a modified example of the first embodiment of the present disclosure.

FIG. 8A is a view schematically illustrating a light-shielding fabric for a curtain-type vertical blind according to a second embodiment of the present disclosure.

FIG. 8B is a view schematically illustrating a light-shielding fabric for a curtain-type vertical blind according to a modified example of the second embodiment of the present disclosure.

FIG. 8C is a view schematically illustrating a light-shielding fabric for a curtain-type vertical blind according to another modified example of the second embodiment of the present disclosure.

FIG. 9A is a view schematically illustrating a light-shielding fabric for a curtain-type vertical blind according to a modified example of the second embodiment of the present disclosure.

FIG. 9B is a view schematically illustrating a light-shielding fabric for a curtain-type vertical blind according to another modified example of the second embodiment of the present disclosure.

FIG. 9C is a view schematically illustrating a light-shielding fabric for a curtain-type vertical blind according to another modified example of the second embodiment of the present disclosure.

FIG. 10 is a view schematically illustrating the light-shielding fabric for a curtain-type vertical blind, in which inner edges of two light-shielding portions are coupled or attached to outer edges of a light-transmitting portion in the light-shielding fabric according to the first and second embodiments of the present disclosure.

FIG. 11 is a view schematically illustrating the light-shielding fabric for a curtain-type vertical blind, in which in a state in which the two light-shielding portions are arranged at one side and the other side of one light-transmitting portion in the light-shielding fabric according to the first and second embodiments of the present disclosure, the light-transmitting portion is attached or coupled to the light-shielding portion from a position of half or less the width of the light-shielding portion in a width direction to an outer edge of the light-shielding portion.

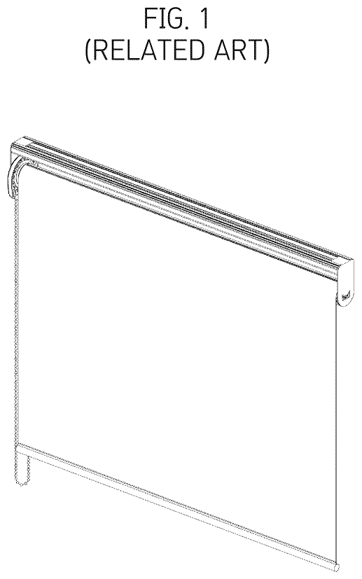

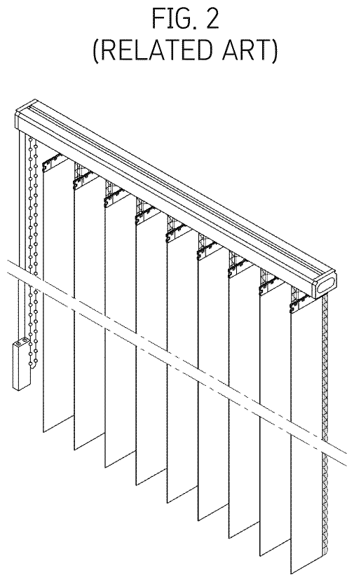

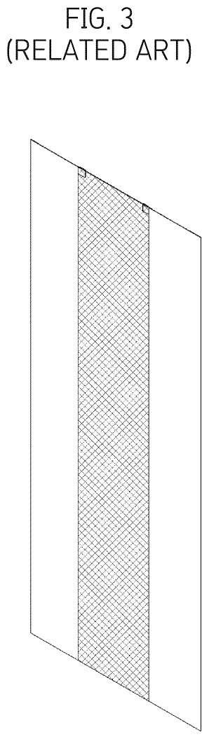

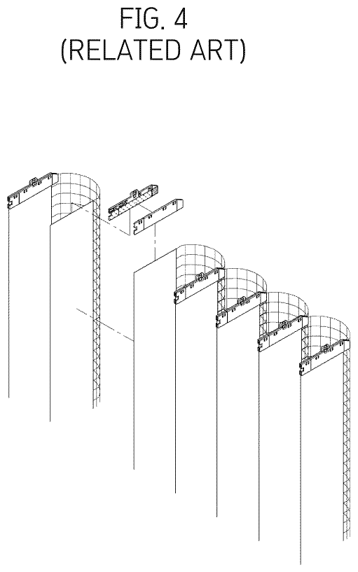

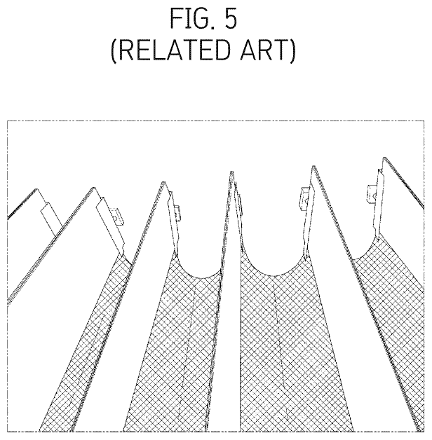

In FIG. 12A, (a) is a view illustrating a front surface of the light-shielding fabric for a curtain-type vertical blind according to the first and second embodiments of the present disclosure, and (b) is a view illustrating a rear surface of the light-shielding fabric for a curtain-type vertical blind according to the first and second embodiments of the present disclosure, in which (a) and (b) of FIG. 12A are views schematically illustrating the light-shielding fabric, in which in the state in which the two light-shielding portions are arranged at one side and the other side of one light-transmitting portion, the light-transmitting portion is attached or coupled to the light-shielding portion from a position exceeding half the width of the light-shielding portion in the width direction to an outer edge of the light-shielding portion.

FIG. 12B is a partially enlarged view illustrating the attachment or coupling configuration of the light-transmitting portion to the light-shielding portion in the light-shielding fabric in FIG. 12A.

FIG. 12C is a view schematically illustrating a state in which the two light-shielding portions are arranged at a predetermined interval in parallel with each other in the light-shielding fabric in FIG. 12A when viewed from above.

FIG. 12D is a view schematically illustrating a state in which the light-shielding fabrics in FIG. 12C are arranged to be adjacent to one another and fixed when viewed from above.

FIG. 13 is a view schematically illustrating the light-shielding fabric for a curtain-type vertical blind, in which the outer edges of the two light-shielding portions are coupled or attached to the outer edges of the light-transmitting portion in the light-shielding fabric for a curtain-type vertical blind according to the first and second embodiments of the present disclosure.

FIG. 14 is a view schematically illustrating a state in which a blind manufactured by using the light-shielding fabric for a curtain-type vertical blind in FIG. 12A or FIG. 13 is folded.

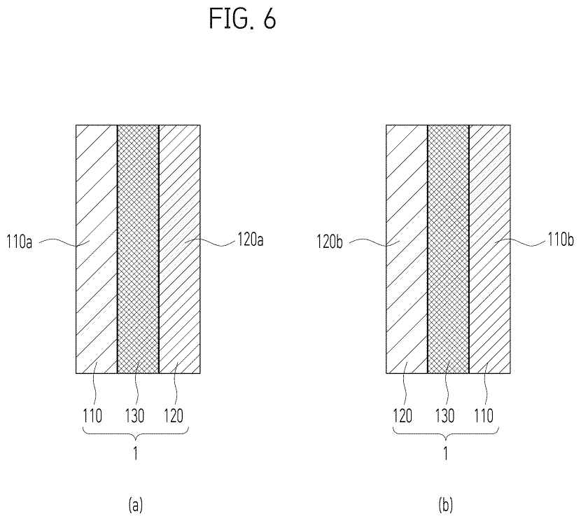

FIG. 15 is a view illustrating a process of manufacturing a curtain-type vertical blind according to a fourth embodiment of the present disclosure by using the light-shielding fabric in FIGS. 6 to 9C and 12A to 13.

FIG. 16 is a view illustrating a state in which a second light-shielding portion 120 and a first light-shielding portion 110 are additionally disposed at outermost sides of left and right sides during a process of manufacturing the curtain-type vertical blind according to the embodiment of the present disclosure in FIG. 15.

FIG. 17A is a view illustrating an embodiment of a fixing means for fixing the light-shielding fabrics during a process of manufacturing the curtain-type vertical blind according to the fourth embodiment of the present disclosure.

FIG. 17B is a view illustrating another embodiment of the fixing means for fixing the light-shielding fabrics during the process of manufacturing the curtain-type vertical blind according to the fourth embodiment of the present disclosure.

FIG. 18 is a schematic view of the curtain-type vertical blind according to the embodiment of the present disclosure manufactured by using the light-shielding fabric in FIGS. 6 to 9C and 12A to 13.

FIG. 19 is a view illustrating a process of manufacturing the curtain-type vertical blind according to the embodiment of the present disclosure by using the light-shielding fabric in FIGS. 6 to 9C and 12A to 13.

FIG. 20 is a view illustrating a state in which the curtain-type vertical blind according to the embodiment of the present disclosure is folded.

FIG. 21 is a view illustrating a state in which the curtain-type vertical blind according to the embodiment of the present disclosure is unfolded.

FIG. 22 is a view illustrating a state in which the blinds, which are in the state in FIG. 21, are rotated about a vertical axis in one direction, and the blinds are arranged in a row in a horizontal direction, such that a window or doorway is closed.

FIG. 23 is a view illustrating a state in which the blinds, which are in the state in FIG. 21, are rotated about the vertical axis in a direction opposite to the direction in FIG. 22, and the blinds are arranged in a row in the horizontal direction, such that an opening of the window or doorway is closed.

FIGS. 24 to 30 are views schematically illustrating light-shielding fabrics for a curtain-type vertical blind according to a fifth embodiment of the present disclosure.

FIG. 31 is a view illustrating a process of manufacturing the curtain-type vertical blind according to the embodiment of the present disclosure by using the light-shielding fabric in FIGS. 27 and 30.

FIG. 32 is a schematic view of the curtain-type vertical blind according to the embodiment of the present disclosure manufactured by using the light-shielding fabric in FIG. 27.

FIGS. 33 to 37 are views schematically illustrating light-shielding fabrics for a curtain-type vertical blind according to a sixth embodiment of the present disclosure.

### DETAILED DESCRIPTION OF THE EMBODIMENT

The objects, features, and advantages of the present disclosure will become more apparent with reference to the following embodiments associated with the accompanying drawings.

Specific structural or functional descriptions of embodiments of the present disclosure are exemplified only for the purpose of explaining the embodiments according to the concept of the present disclosure, the embodiments according to the concept of the present disclosure may be carried out in various forms, and it should not be interpreted that the present disclosure is limited to the embodiments described in this specification or application.

Because the embodiments according to the concept of the present disclosure may be variously changed and may have various forms, specific embodiments will be illustrated in the drawings and described in detail in the present specification or application. However, the descriptions of the specific embodiments are not intended to limit embodiments according to the concept of the present disclosure to the specific embodiments, but it should be understood that the present disclosure covers all modifications, equivalents and alternatives falling within the spirit and technical scope of the present disclosure.

The terms such as “first” and/or “second” may be used to describe various constituent elements, but these constituent elements should not be limited by these terms. These terms are used only for the purpose of distinguishing one constituent element from other constituent elements. For example, without departing from the scope according to the concept of the present disclosure, the first constituent element may be referred to as the second constituent element, and similarly, the second constituent element may also be referred to as the first constituent element.

When one constituent element is described as being “connected” or “coupled” to another constituent element, it should be understood that one constituent element can be connected or coupled directly to another constituent element, and an intervening constituent element can also be present between the constituent elements. When one constituent element is described as being “connected directly to” or “coupled directly to” another constituent element, it should be understood that no intervening constituent element is present between the constituent elements. Other expressions, that is, “between” and “just between” or “adjacent to” and “directly adjacent to”, for explaining a relationship between constituent elements, should be interpreted in a similar manner.

The terms used in the present specification are used only for the purpose of describing particular embodiments and are not intended to limit the present disclosure. Singular expressions include plural expressions unless clearly described as different meanings in the context. In the present application, it will be appreciated that terms “including” and “having” are intended to designate the existence of characteristics, numbers, steps, operations, constituent elements, and components described herein or a combination thereof, and do not exclude a possibility of the existence or addition of one or more other characteristics, numbers, steps, operations, constituent elements, and components, or a combination thereof in advance.

Unless otherwise defined, all terms used herein have the same meaning as commonly understood by those skilled in the art to which the present disclosure pertains. The terms such as those defined in a commonly used dictionary should be interpreted as having meanings consistent with meanings in the context of related technologies and should not be interpreted as ideal or excessively formal meanings unless explicitly defined in the present specification.

Hereinafter, the present disclosure will be described in detail by describing the embodiments of the present disclosure with reference to the accompanying drawings. Like reference numerals indicated in the respective drawings refer to like members.

### First Embodiment

First, a light-shielding fabric 1 for a curtain-type vertical blind 100 according to a first embodiment of the present disclosure will be described with reference to FIG. 6.

A material of the light-shielding fabric 1 for a curtain-type vertical blind according to the first embodiment of the present disclosure is not limited to a fabric made by weaving a plurality of fiber yarns, but a flexible sheet material, such as a non-woven fabric, a knitted fabric, a synthetic resin sheet, or a PVC sheet may be used.

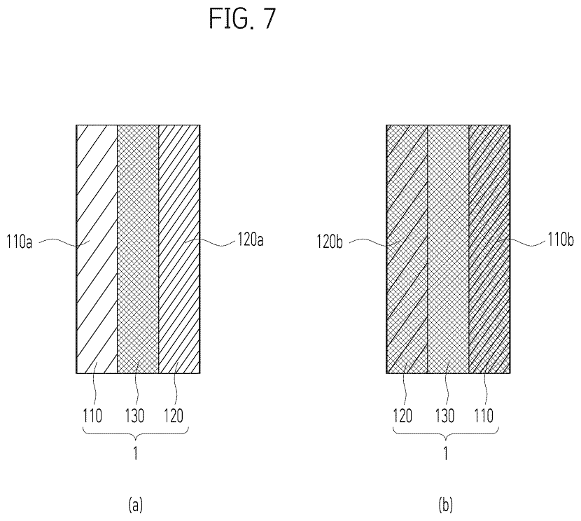

In FIG. 6, (a) is a view illustrating a front surface of a light-shielding fabric 1 for a curtain-type vertical blind 100 according to a first embodiment of the present disclosure, (b) is a view illustrating a rear surface of the light-shielding fabric 1 for a curtain-type vertical blind according to the first embodiment of the present disclosure. In FIG. 7, (a) is a view illustrating the front surface of the light-shielding fabric 1 for the curtain-type vertical blind 100 according to the modified example of the first embodiment of the present disclosure, and (b) is a view illustrating the rear surface of the light-shielding fabric 1 for a curtain-type vertical blind according to the modified example of the first embodiment of the present disclosure.

The light-shielding fabric 1 for the curtain-type vertical blind 100 according to the first embodiment of the present disclosure includes a single light-transmitting portion 130 capable of transmitting light, a first light-shielding portion 110 disposed at one side of the light-transmitting portion 130 and attached or coupled to the light-transmitting portion, and a second light-shielding portion 120 disposed at the other side of the light-transmitting portion 130 and attached or coupled to the light-transmitting portion. For example, according to the first embodiment of the present disclosure, as illustrated in (a) and (b) of FIG. 6, the first and second light-shielding portions 110 and 120 may be arranged at left and right sides of the single light-transmitting portion 130. In this case, the light-transmitting portion 130 and the first and second light-shielding portions 110 and 120 may be integrally woven or integrated by being attached or coupled to one another. As illustrated in (a) of FIG. 6, a front surface 110a of the first light-shielding portion 110 and a rear surface 120b of the second light-shielding portion 120 may have the same first color A (hatched portion with large intervals). Further, as illustrated in (b) of FIG. 6, a rear surface 110b of the first light-shielding portion 110 and a front surface 120a of the second light-shielding portion 120 may have the same second color B (hatched portion with narrow intervals), and the first color A may be different from the second color B.

In addition, for example, according to the modified example of the first embodiment of the present disclosure, as illustrated in FIG. 7, the light-transmitting portion 130 may be arranged to cover the entire front or rear surfaces of the first light-shielding portion 110 and the second light-shielding portion 120. That is, the first light-shielding portion 110 and the second light-shielding portion 120 may be disposed at a predetermined interval at one side and the other side of the single light-transmitting portion 130, respectively.

In the light-shielding fabric 1 for the curtain-type vertical blind 100 according to the modified example of the first embodiment, the light-transmitting portion 130, which has a mesh or net shape and is manufactured to transmit light and wind, is arranged on the rear surfaces of the first light-shielding portion 110 and the second light-shielding portion 120. Therefore, as illustrated in (b) of FIG. 7, colors of the rear surfaces of the first light-shielding portion 110 and the second light-shielding portion 120 may be visible from the rear surface through the light-transmitting portion 130.

In the embodiment in FIG. 7, the light-transmitting portion 130 and the first and second light-shielding portions 110 and 120 may be integrally woven. In addition, the light-transmitting portion 130, which overlaps the first and second light-shielding portions 110 and 120, may be partially or entirely attached or coupled to each other. As illustrated in (a) of FIG. 7, a front surface 110a of the first light-shielding portion 110 and a rear surface 120b of the second light-shielding portion 120 may have the same first color A (hatched portion with large intervals). Further, as illustrated in (b) of FIG. 7, a rear surface 110b of the first light-shielding portion 110 and a front surface 120a of the second light-shielding portion 120 may have the same second color B (hatched portion with narrow intervals), and the first color A may be different from the second color B.

The front surface 110a and the rear surface 110b of the first light-shielding portion 110 of the light-shielding fabric 1 for the curtain-type vertical blind 100 according to the first embodiment of the present disclosure and the modified example thereof may have different colors, and the first light-shielding portion 110 may be made of a double-woven fabric. For example, in this case, colors of warp yarns and/or weft yarns arranged in the front surface 110a may be selected as the first color A, and colors of warp yarns and/or weft yarns arranged in the rear surface 110b may be selected as the second color B. The second light-shielding portion 120 may also be woven in the same way as the first light-shielding portion 110. In addition, for example, the first light-shielding portion 110 and the second light-shielding portion 120 each have the front surface in which the warp yarns and/or the weft yarns are arranged, and the rear surface in which the other warp yarns and/or the other weft yarns are arranged. The first light-shielding portion 110 and the second light-shielding portion 120 may each be made of a triple-woven fabric in which blackout fibers are arranged at a center between the front surface and the rear surface. In this case, for example, the color of the warp yarns and/or the weft yarns arranged in the front surface of each of the first and second light-shielding portions 110 and 120 is selected to be different from the color of the warp yarns and/or the weft yarns arranged in the rear surface of each of the first and second light-shielding portions 110 and 120, such that the triple-woven fabric may be woven.

In order to manufacture the light-shielding fabric 1 for the curtain-type vertical blind 100 according to the first embodiment of the present disclosure and the modified example thereof, for the first and second light-shielding portions 110 and 120, a fabric capable of shielding the interior with less light and wind circulation may be used, and a fabric such as an opaque fabric, a non-woven fabric, a knitted fabric, a synthetic resin sheet, a PVC sheet, and the like may be used. In addition, for the light-transmitting portion 130, a woven fabric made of a mesh material may be used that may allow air to flow from/to an external space and transmit a predetermined amount of light while the first and second light-shielding portions 110 and 120 block light or wind. However, the present disclosure is not limited thereto. A mesh cloth, which is flexible and thin, may be applied. The light-transmitting portion 130 may be functionally made of a semi-transparent material capable of appropriately reducing a degree of concealment and illumination of the interior.

In case that the light-transmitting portion 130 and the first and second light-shielding portions 110 and 120 of the light-shielding fabric 1 of the curtain-type vertical blind according to the first embodiment of the present disclosure and the modified example thereof are woven integrally, the light-transmitting portion 130 is woven in a mesh or net shape by a single weaving machine to transmit light and wind, such that the first and second light-shielding portions 110 and 120, which are disposed at one side and the other side of the light-transmitting portion 130 and attached or coupled to the light-transmitting portion 130, may be woven with a density capable of blocking the transmission of light or wind. The front surface 110a of the first light-shielding portion 110 may be woven by using fiber yarns having the first color A (e.g., white), the rear surface 110b of the first light-shielding portion 110 may be woven by using fiber yarns having the second color B (e.g., beige, sky-blue, pink, or the like), the front surface 120a of the second light-shielding portion 120 may be woven by using fiber yarns having the second color B (e.g., beige, sky-blue, pink, or the like), and the rear surface 120b of the second light-shielding portion 120 may be woven by using fiber yarns having the first color A (e.g., white).

In addition, the light-shielding fabric 1 of the curtain-type vertical blind according to the first embodiment of the present disclosure and the modified example thereof may be manufactured by attaching or coupling two opposite side edges of the light-transmitting portion 130 to the first and second light-shielding portions 110 and 120 in the longitudinal direction.

When the curtain-type vertical blind is manufactured by using the light-shielding fabric for a curtain-type vertical blind according to the first embodiment of the present disclosure and the modified example thereof, the light-transmitting portion and the light-shielding portions may be integrated with each other, and the light-transmitting portion may be controlled by the weight of the light-shielding portions, such that straightness may be imparted toward the lower side of the light-transmitting portion, which may prevent the light-transmitting portion from becoming wavy.

In addition, when the curtain-type vertical blind is manufactured by using the light-shielding fabric for a curtain-type vertical blind according to the first embodiment of the present disclosure and the modified example thereof, the closed blinds are not spaced apart from one another, and the shapes of the blinds may be maintained, a gap may not be formed between the blinds to prevent the interior from being visible from the outside and maintain uniform appearances of the blinds.

In addition, when the curtain-type vertical blind is manufactured by using the light-shielding fabric for a curtain-type vertical blind according to the first embodiment of the present disclosure and the modified example thereof, a rotational force may be simultaneously transmitted to the lower side of the blind by the weight of the light-shielding portions when the blind is rotated to adjust the angle of the blind, the lower side of the blind may be rotated in the same way as the upper side of the blind.

### Second Embodiment

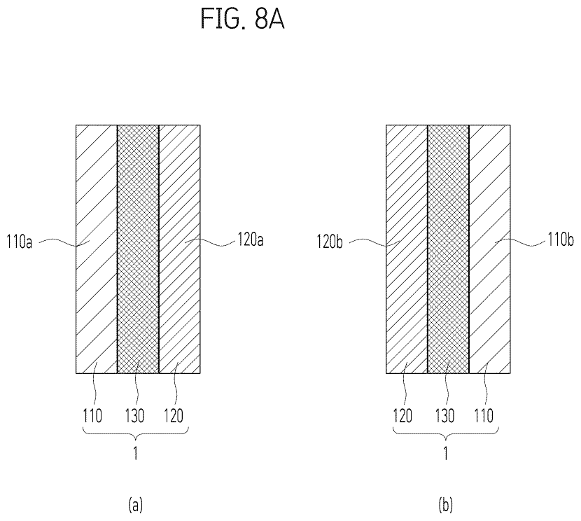

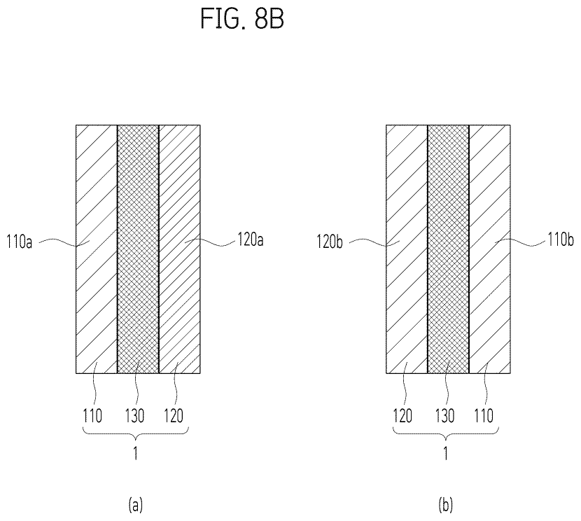

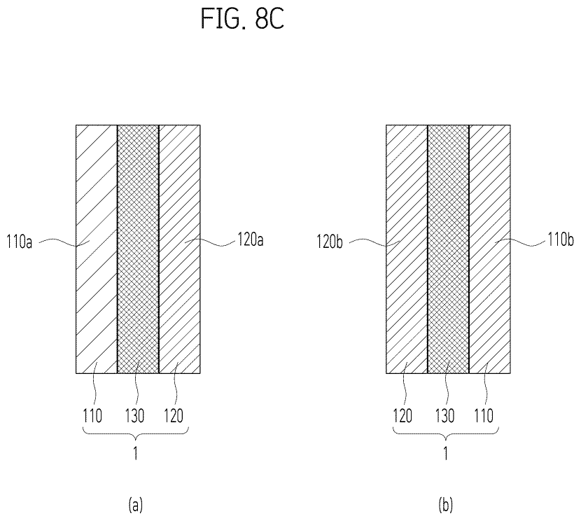

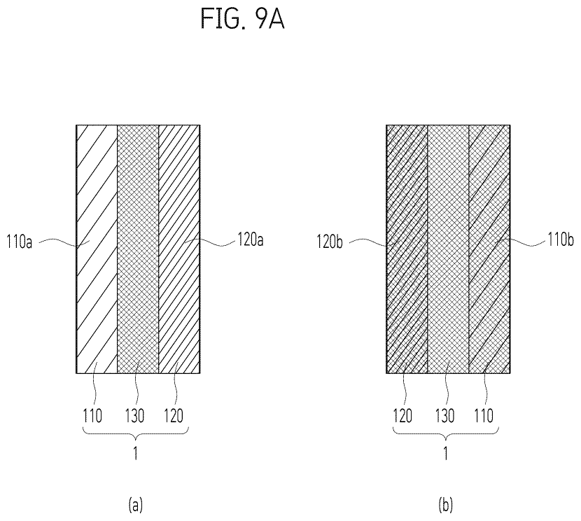

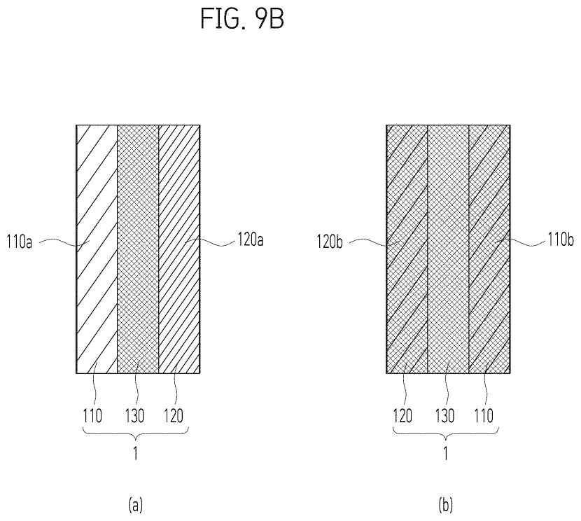

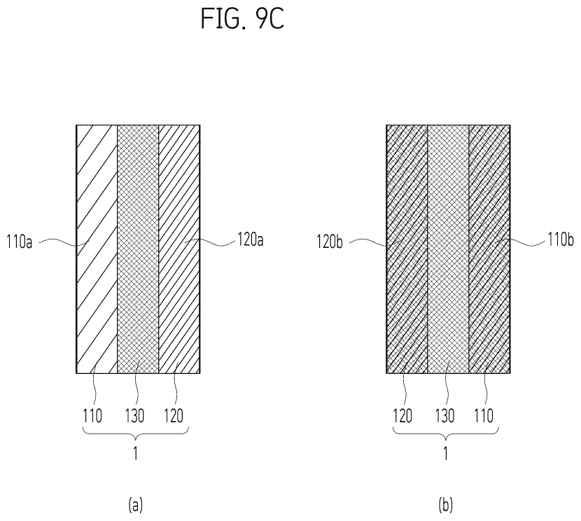

Next, the light-shielding fabric 1 for the curtain-type vertical blind 100 according to the second embodiment of the present disclosure will be described with reference to FIGS. 8A to 9C. In the description of the light-shielding fabric 1 according to the second embodiment, descriptions of the parts similar in configurations and operations to the parts of the light-shielding fabric 1 according to the first embodiment will be omitted.

In the first embodiment of the present disclosure and the modified example thereof, the front surface 110a of the first light-shielding portion 110 and the rear surface 120b of the second light-shielding portion 120 of the light-shielding fabric 1 have the first color A, and the rear surface 110b of the first light-shielding portion 110 and the front surface 120a of the second light-shielding portion 120 have the second color B. In contrast, the second embodiment and the modified example thereof differ from the first embodiment of the present disclosure and the modified example thereof in that the front surface 110a of the first light-shielding portion 110 of the light-shielding fabric 1 has the first color A, and the front surface 120a of the second light-shielding portion 120 has the second color B.

FIG. 8A is a view schematically illustrating the light-shielding fabric for a curtain-type vertical blind according to the second embodiment of the present disclosure, FIG. 8B is a view schematically illustrating the light-shielding fabric for a curtain-type vertical blind according to the modified example of the second embodiment of the present disclosure, FIG. 8C is a view schematically illustrating the light-shielding fabric for a curtain-type vertical blind according to another modified example of the second embodiment of the present disclosure; FIG. 9A is a view schematically illustrating the light-shielding fabric for a curtain-type vertical blind according to the modified example of the second embodiment of the present disclosure, FIG. 9B is a view schematically illustrating the light-shielding fabric for a curtain-type vertical blind according to another modified example of the second embodiment of the present disclosure, and FIG. 9C is a view schematically illustrating the light-shielding fabric for a curtain-type vertical blind according to another modified example of the second embodiment of the present disclosure.

As illustrated in FIG. 8A, the light-shielding fabric 1 for the curtain-type vertical blind 100 according to the second embodiment of the present disclosure includes a single light-transmitting portion 130 capable of transmitting light, the first light-shielding portion 110 disposed at one side of the light-transmitting portion 130 and attached or coupled to the light-transmitting portion, and the second light-shielding portion 120 disposed at the other side of the light-transmitting portion 130 and attached or coupled to the light-transmitting portion. For example, according to the second embodiment of the present disclosure, as illustrated in FIGS. 8A to 8C, the first and second light-shielding portions 110 and 120 may be arranged at left and right sides of the single light-transmitting portion 130. In this case, the light-transmitting portion 130 and the first and second light-shielding portions 110 and 120 may be integrally woven or integrated by being attached or coupled to one another. As illustrated in (a) of FIG. 8A, the front surface 110a of the first light-shielding portion 110 may have the first color A (hatched portion with large intervals), and the front surface 120a of the second light-shielding portion 120 may have the second color B (hatched portion with narrow intervals) different from the first color A. In addition, as illustrated in (b) of FIG. 8A, the rear surface 110b of the first light-shielding portion 110 may have the first color A (hatched portion with large intervals), and the rear surface 120b of the second light-shielding portion 120 may have the second color B (hatched portion with narrow intervals). That is, the front surface 110a and the rear surface 110b of the first light-shielding portion 110 may have the same color as the first color A, and the front surface 120a and the rear surface 120b of the second light-shielding portion 120 may have the same color as the second color B. In this case, the color of the rear surface 110b of the first light-shielding portion 110 and the color of the rear surface 120b of the second light-shielding portion 120 are different from each other.

In addition, for example, according to the modified example of the second embodiment of the present disclosure, as illustrated in FIGS. 9A to 9C, the light-transmitting portion 130 may be arranged to cover the entire front or rear surfaces of the first light-shielding portion 110 and the second light-shielding portion 120. That is, the first light-shielding portion 110 and the second light-shielding portion 120 may be disposed at a predetermined interval at one side and the other side of the single light-transmitting portion 130, respectively.

In the light-shielding fabric 1 for the curtain-type vertical blind 100 according to the modified example of the second embodiment, the light-transmitting portion 130, which has a mesh or net shape and is manufactured to transmit light and wind, is arranged on the rear surfaces of the first light-shielding portion 110 and the second light-shielding portion 120. Therefore, as illustrated in (b) of FIG. 9A, (b) of FIG. 9B, and (b) of FIG. 9C, colors of the rear surfaces of the first light-shielding portion 110 and the second light-shielding portion 120 may be visible from the rear surface through the light-transmitting portion 130.

In the embodiment of FIGS. 9A to 9C, the light-transmitting portion 130 and the first and second light-shielding portions 110 and 120 may be integrally woven. In addition, the light-transmitting portion 130, which overlaps the first and second light-shielding portions 110 and 120, may be partially or entirely attached or coupled to each other.

In the second embodiment, the front surface 110a and the rear surface 110b of the first light-shielding portion 110 may be woven by using fiber yarns having the first color A (e.g., white), and the front surface 120a and the rear surface 120b of the second light-shielding portion 120 may be woven by using fiber yarns having the second color B (e.g., beige, sky-blue, pink, or the like).

In addition, the rear surface 110b of the first light-shielding portion 110 and the rear surface 120b of the second light-shielding portion 120 of the light-shielding fabric 1 for the curtain-type vertical blind 100 according to the modified example of the second embodiment of the present disclosure may have the same color. In this case, as illustrated in FIG. 8B, the color of the rear surface 110b of the first light-shielding portion 110 and the color of the rear surface 120b of the second light-shielding portion 120 may be identical to the first color A that is the color of the front surface 110a of the first light-shielding portion 110. In addition, as illustrated in FIG. 8C, the color of the rear surface 110b of the first light-shielding portion 110 and the color of the rear surface 120b of the second light-shielding portion 120 may be identical to the second color B that is the color of the front surface 120a of the second light-shielding portion 120. In addition, the color of the rear surface 110b of the first light-shielding portion 110 and the color of the rear surface 120b of the second light-shielding portion 120 may be a color other than the first color A and the second color B.

The first light-shielding portion 110 and the second light-shielding portion 120 of the light-shielding fabric 1 for the curtain-type vertical blind 100 according to the second embodiment of the present disclosure and the modified example thereof may also be manufactured by a double-woven or triple-woven fabric.

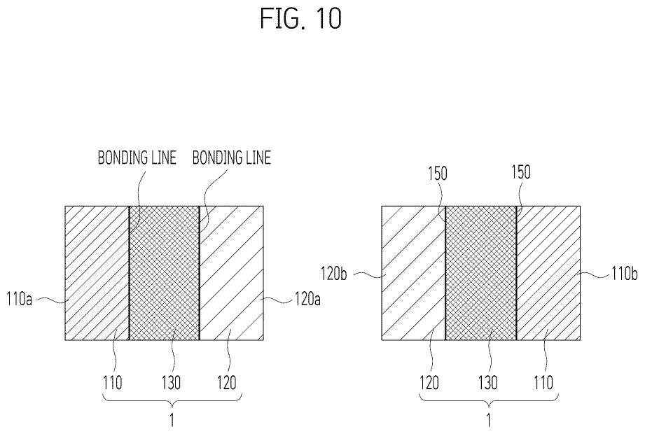

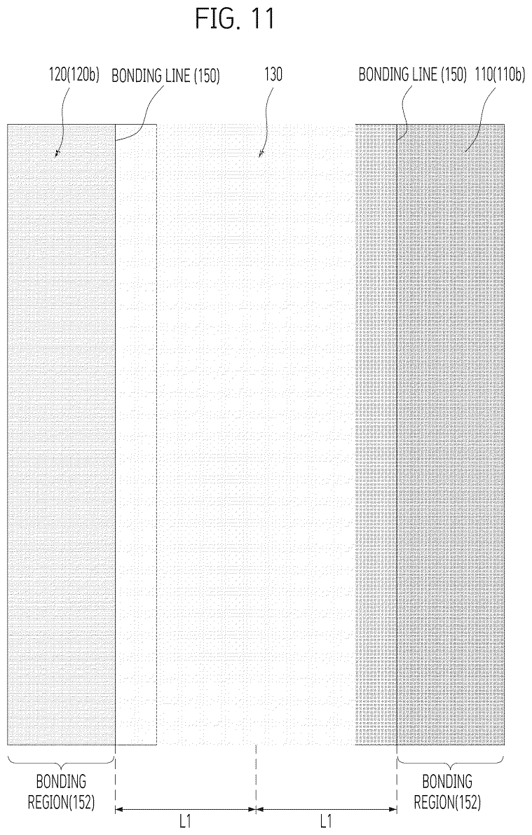

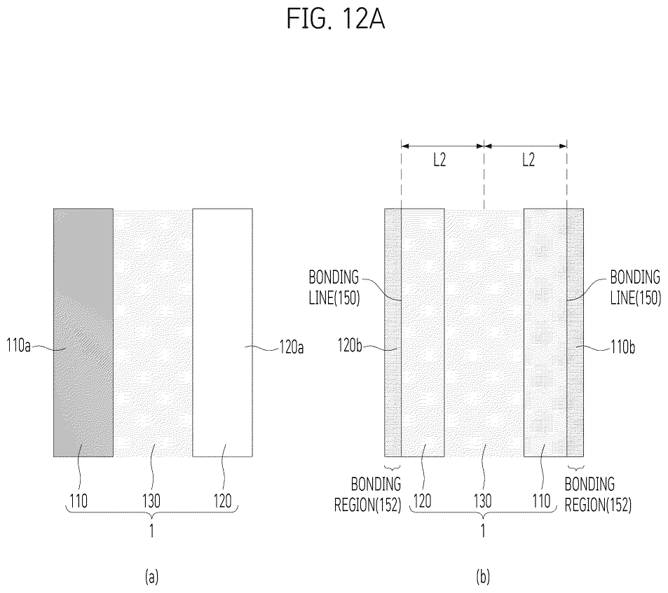

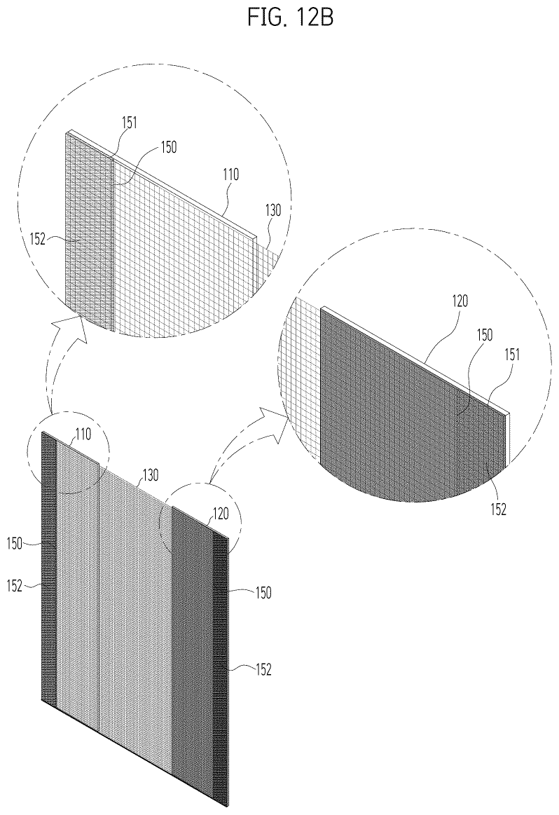

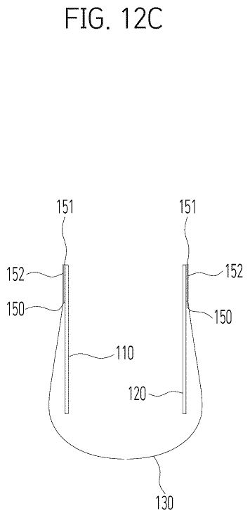

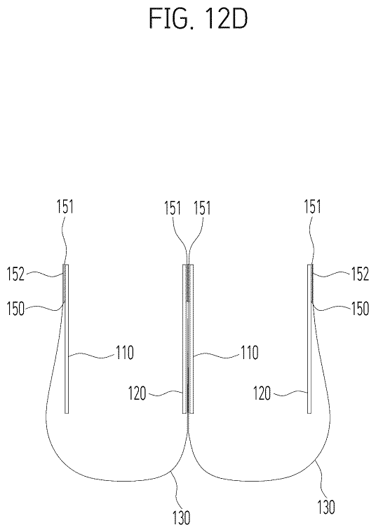

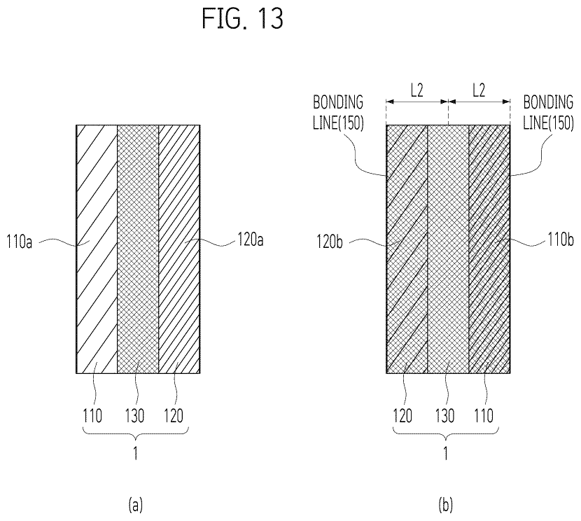

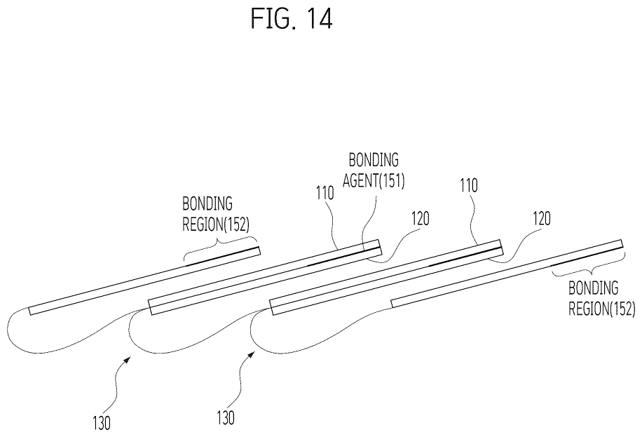

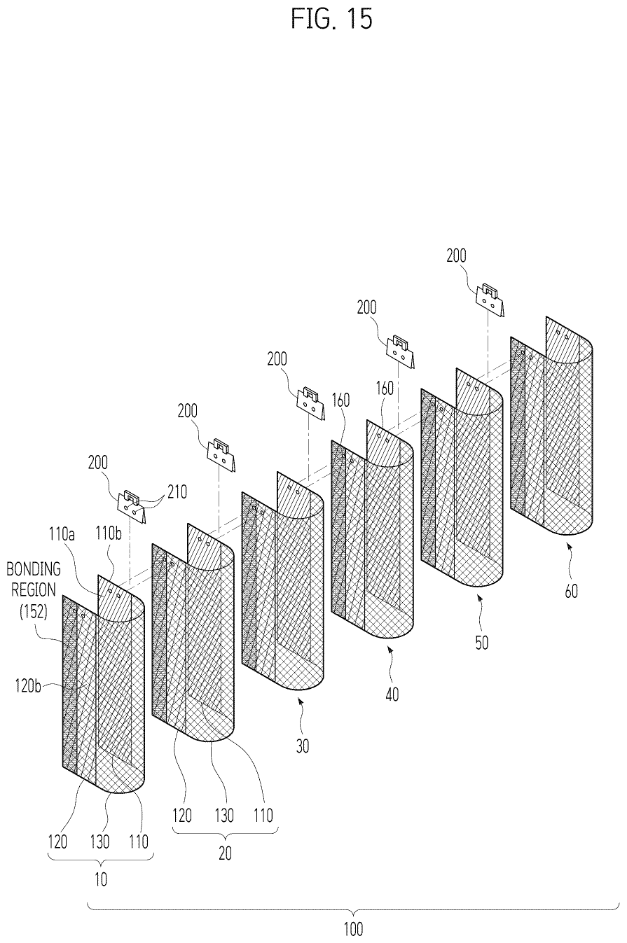

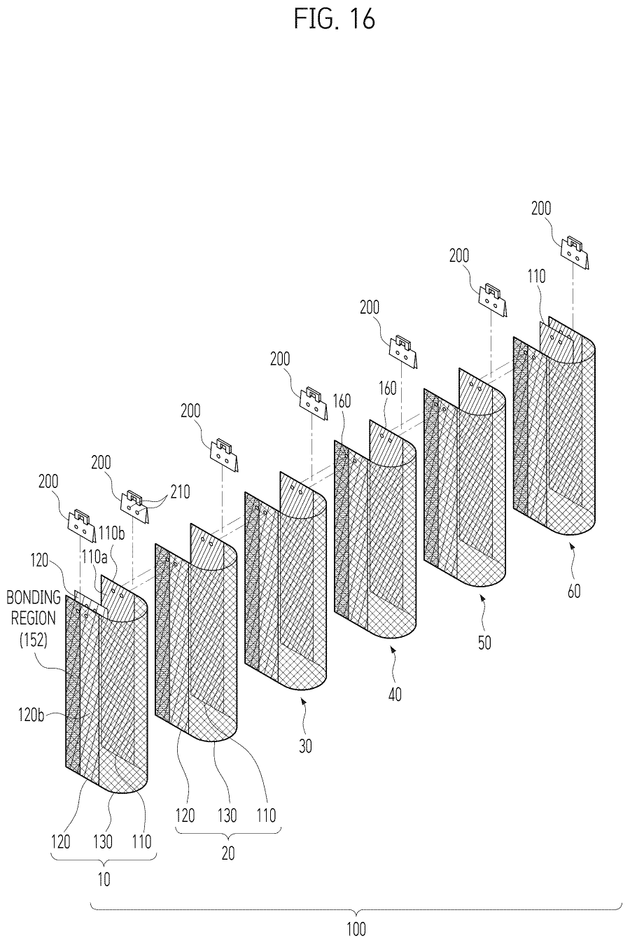

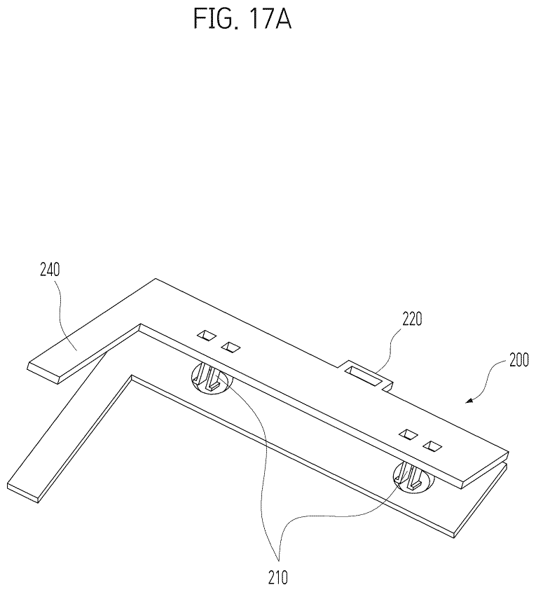

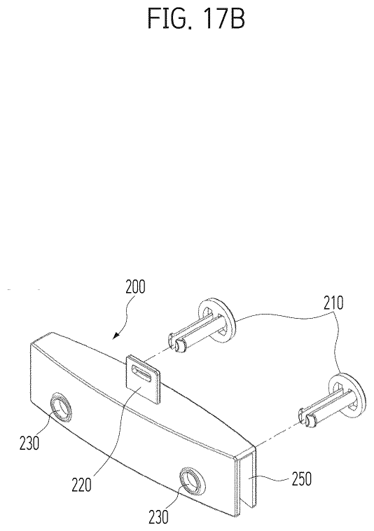

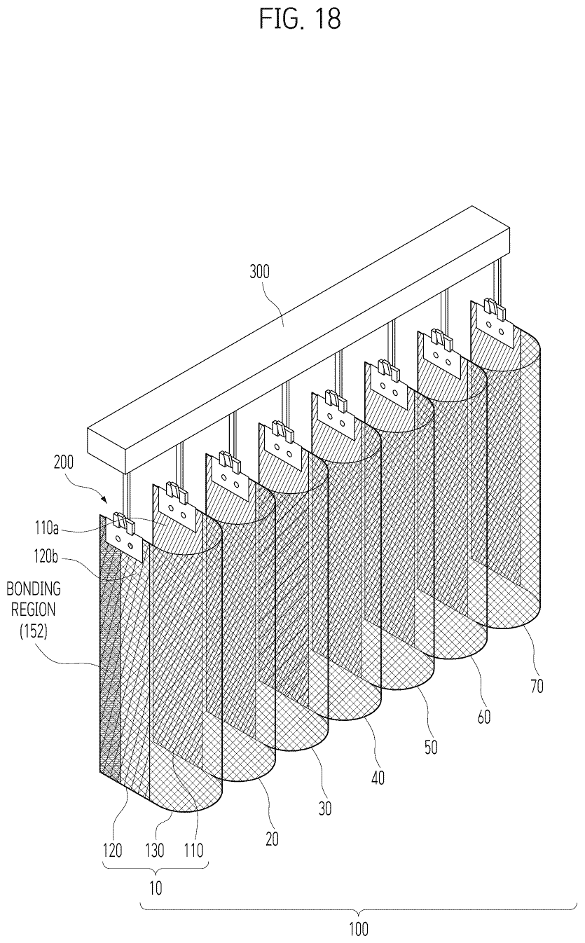

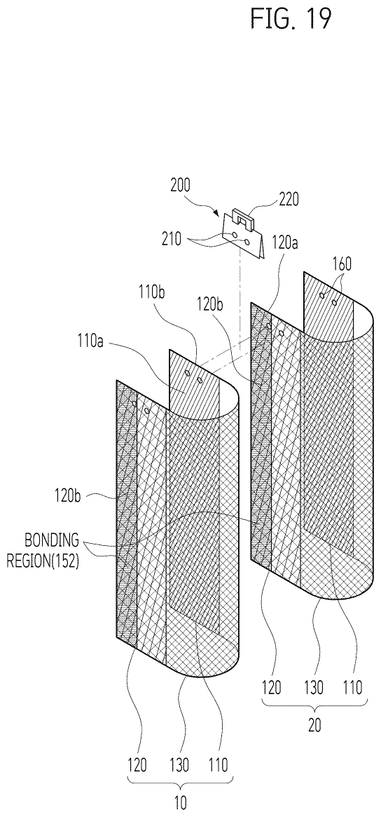

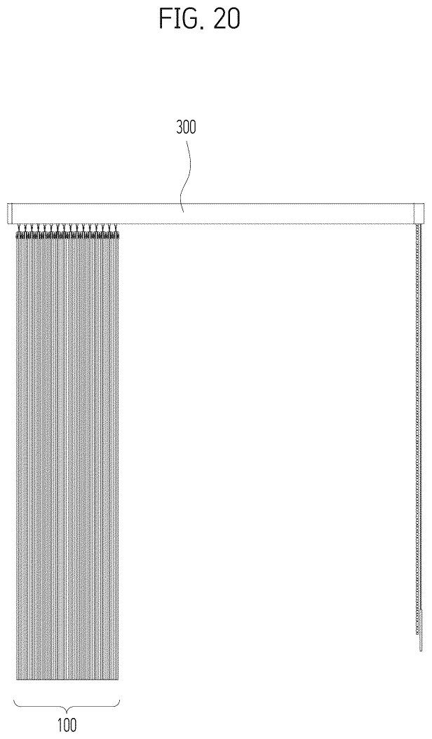

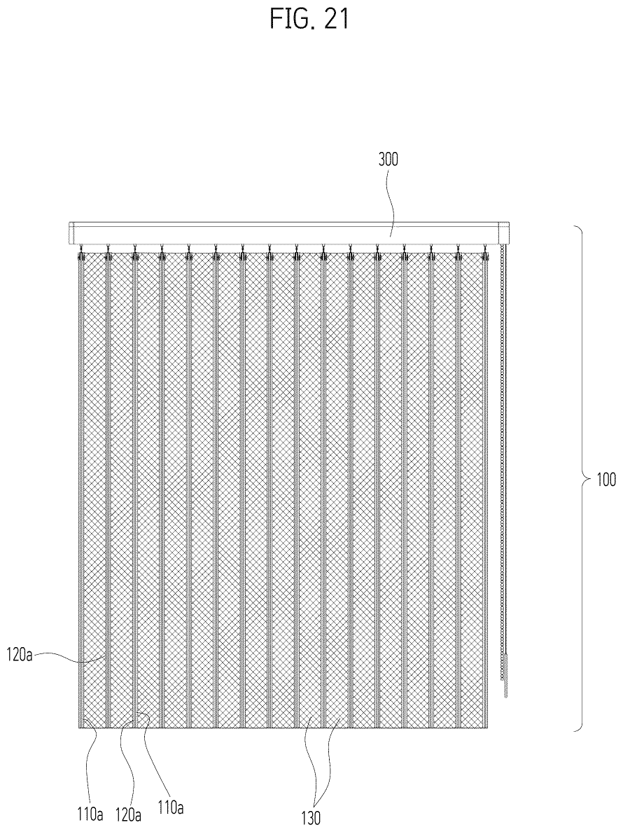

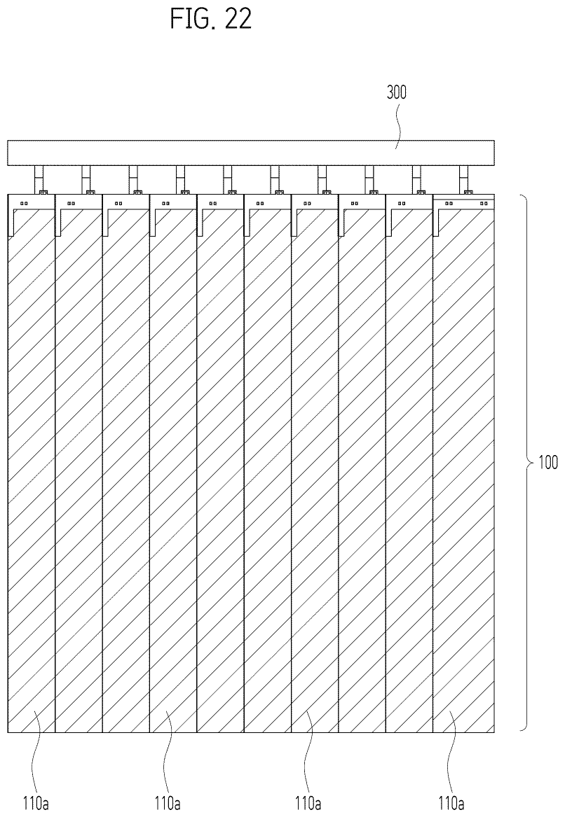

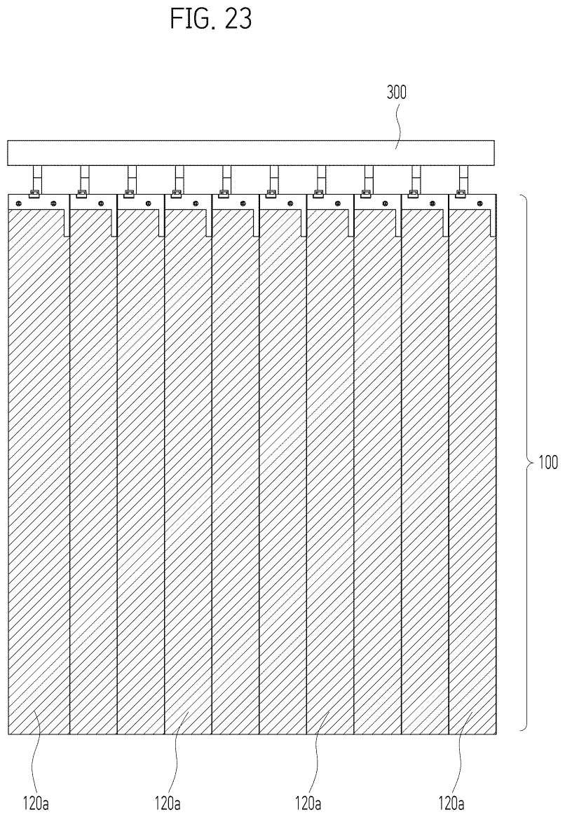

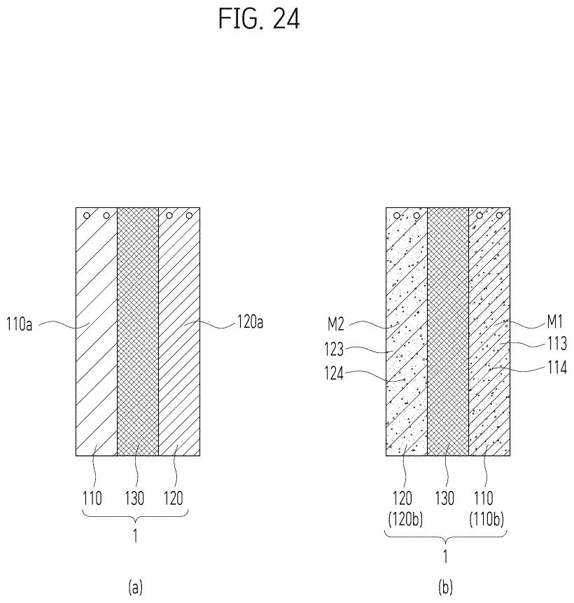

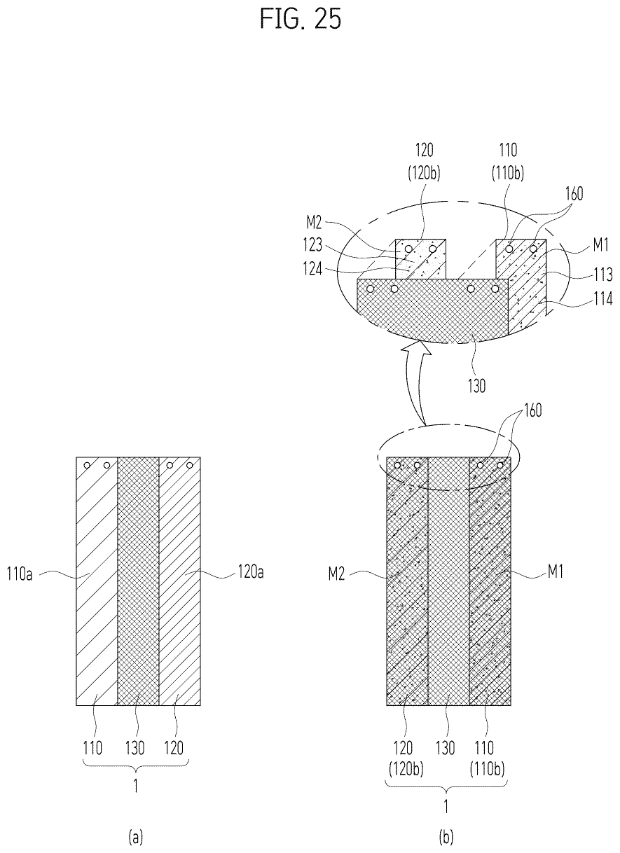

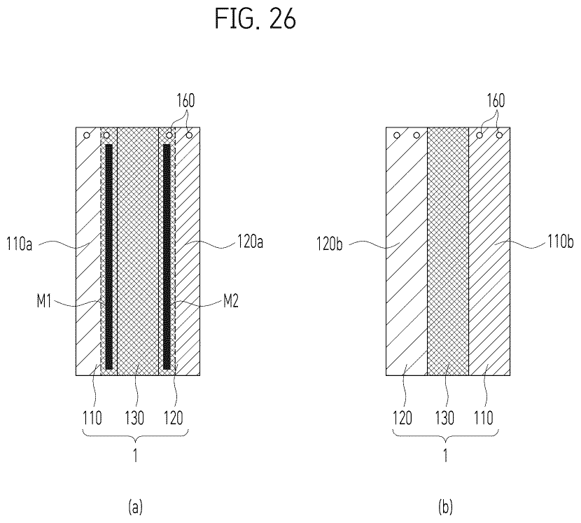

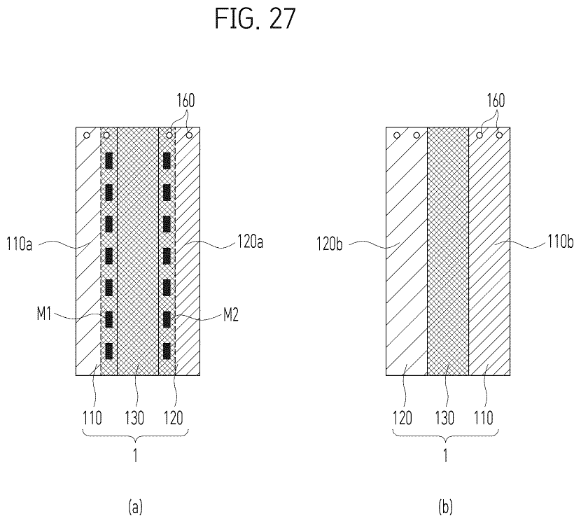

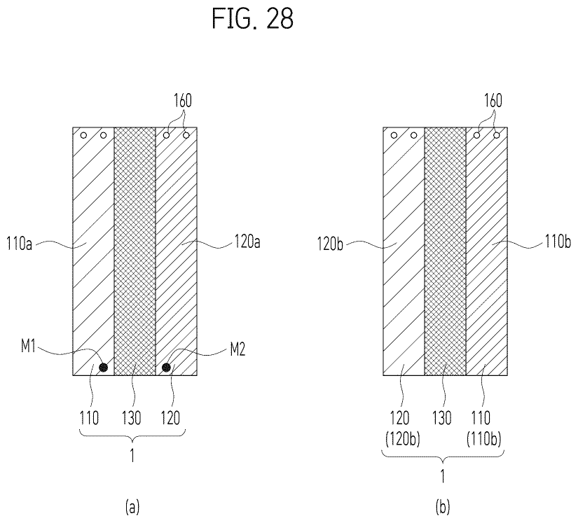

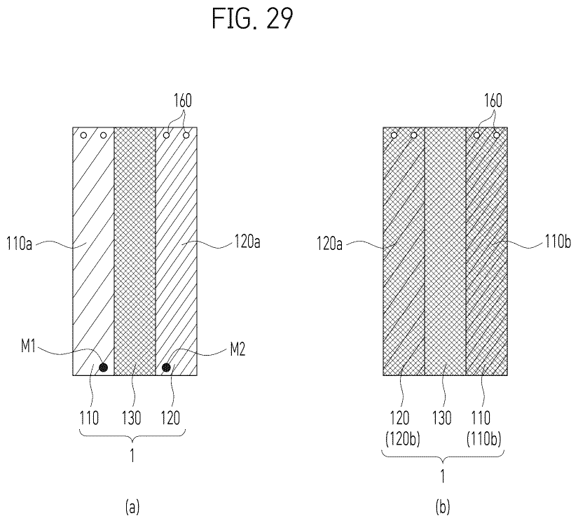

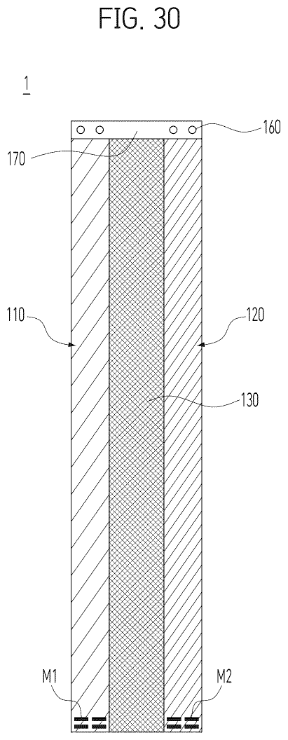

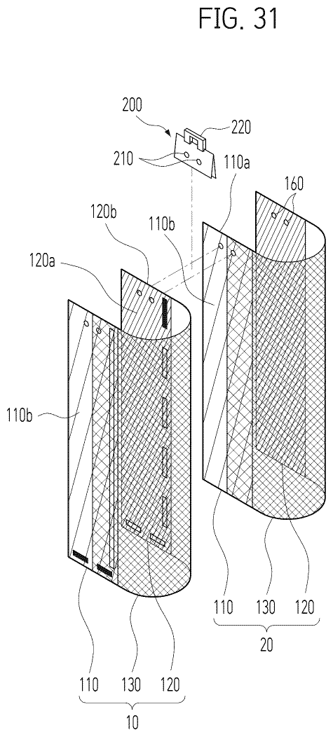

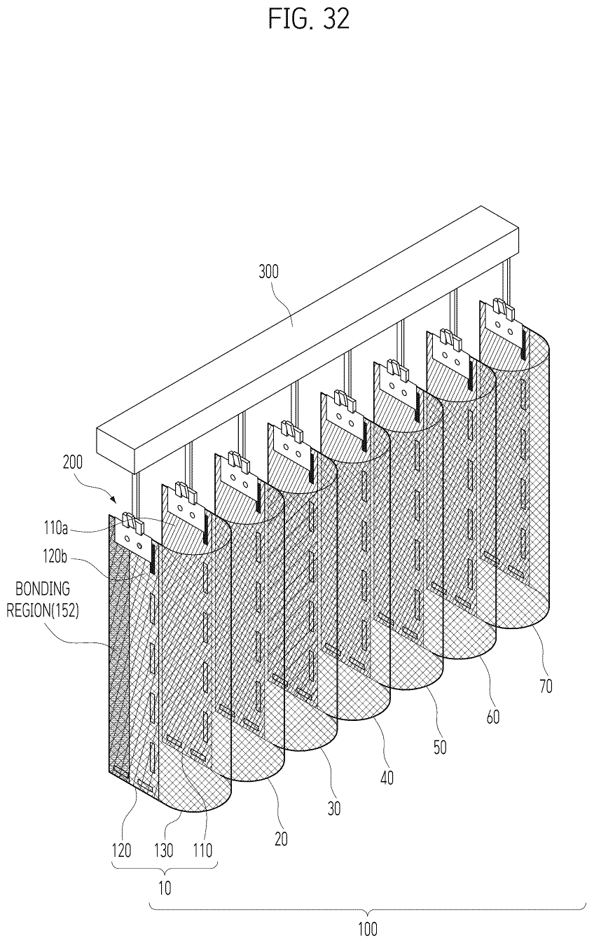

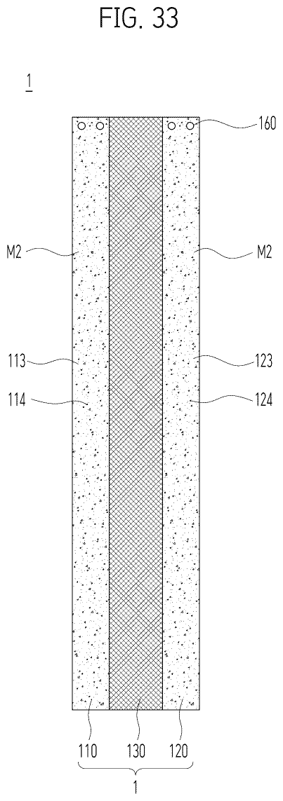

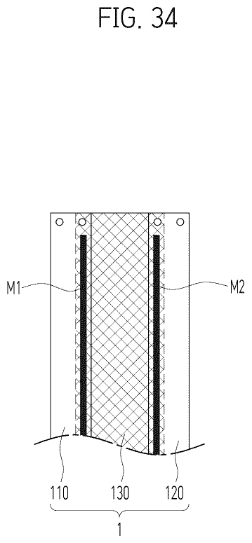

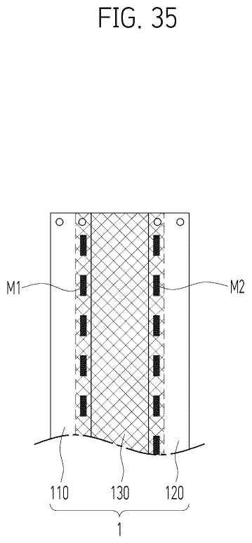

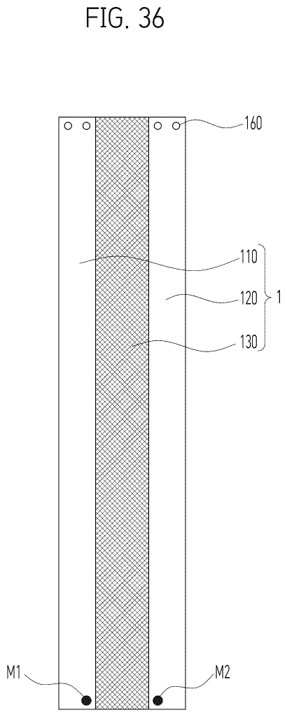

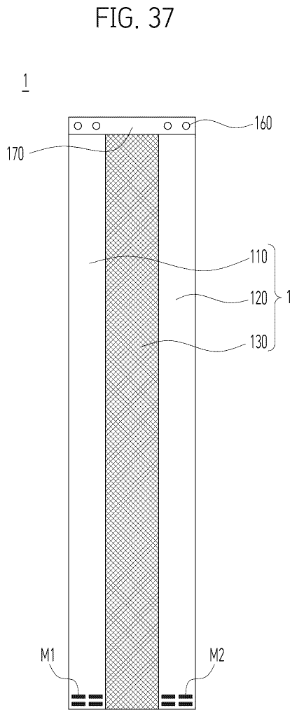

As illustrated in FIG. 10, in the light-shielding fabric 1 for the curtain-type vertical blind 100 according to the first and second embodiments of the present disclosure, the two opposite side edges of the light-transmitting portion 130 may be attached or coupled to the inner edges of the first and second light-shielding portions 110 and 120. In addition, as illustrated in FIG. 11, in the light-shielding fabric 1 for the curtain-type vertical blind 100 according to the modified example of the first embodiment and the modified example of the second embodiment of the present disclosure, the light-transmitting portion 130 may be attached or coupled from a position of half or less the width of one surface of each of the first and second light-shielding portions 110 and 120 in a width direction along the longitudinal direction to the outer edges of the first and second light-shielding portions 110 and 120.

However, in case that the two opposite side edges of the light-transmitting portion 130 may be coupled or attached to the inner edges of the first and second light-shielding portions 110 and 120 as illustrated in FIG. 10, or in case that the light-transmitting portion 130 is attached or coupled from the position of half or less the width of one surface of each of the first and second light-shielding portions 110 and 120 in a width direction along the longitudinal direction to the outer edges of the first and second light-shielding portions 110 and 120, i.e., a region 152 in which the light-transmitting portion 130 is bonded (attached or coupled) to one surface of each of the first and second light-shielding portions 110 and 120 along the longitudinal direction accounts for 50% or more of the width of the first and second light-shielding portions 110 and 120 as illustrated in FIG. 11, the light-shielding portions 110 and 120 may be spaced apart from one another by the nature of the light-transmitting portion 130 being unfolded when the blind is closed by adjusting an angle of the blind to block light or wind. That is, distances (L1 in FIG. 11) from the two opposite edges (bonding portions) to the central portion of the light-transmitting portion 130 become short. Thus, when the blind is folded, a radius of curvature decreases, and stiffness for maintaining an original shape of the light-transmitting portion 130 increases, thereby causing a problem in that the light-shielding portions 110 and 120 are spaced apart from each other.

In order to prevent the above-mentioned problem, as illustrated in (b) of FIG. 12A, in the present disclosure, the light-transmitting portions 130 are arranged to overlap one another to cover the entire surfaces of the first and second light-shielding portions 110 and 120, and the light-transmitting portion 130 is attached or coupled in a width direction along the longitudinal direction from the position 150 exceeding half the width of the front or rear surface of each of the first and second light-shielding portions 110 and 120 (i.e., the position 150 exceeding at least half the width from the inner edge of each of the first and second light-shielding portions 110 and 120) to the outer edges of the first and second light-shielding portions 110 and 120. For example, a bonding line may be formed at the position 150 that exceeds half the width of the front or rear surface in the width direction. In this case, the “bonding line” means a point at which the light-transmitting portion and the light-shielding portion begin to be bonded in a width direction of the light-shielding portion, and the bonding line is formed along the longitudinal direction (in vertical direction) of the light-shielding portion. As illustrated in (b) of FIG. 12A, a region in which the light-transmitting portion 130 is bonded (attached or coupled) to the first and second light-shielding portions 110 and 120 in a width direction along the longitudinal direction accounts for less than 50% of the width of each of the first and second light-shielding portions 110 and 120. The attachment or coupling of the light-transmitting portion 130 and the light-shielding portions 110 and 120 may be performed by a known adhesive (bonding agent), and a detailed description thereof will be omitted.

The light-transmitting portion 130 may be attached or coupled from the position exceeding half the front or rear surface portions of the first and second light-shielding portions 110 and 120 to the outer edge along the longitudinal direction. For example, as illustrated in (b) in FIG. 12A, the region in which the light-transmitting portion 130 is attached or coupled to the rear surface portion of each of the first and second light-shielding portions 110 and 120 in a width direction along the longitudinal direction may account for less than 50% of the width of each of the first and second light-shielding portions 110 and 120. In addition, as illustrated in FIG. 13, outer edges of two opposite sides of the light-transmitting portion 130 may be coupled or attached to outer edges of the rear surface portions of the first and second light-shielding portions 110 and 120. In FIG. 13, the bonding line 150 with the outer edge of the light-transmitting portion 130 may be formed at the outer edge of each of the first and second light-shielding portions 110 and 120. In this case, the light-transmitting portion 130 is attached or coupled only to the outer edge of each of the first and second light-shielding portions 110 and 120. The light-transmitting portion 130 is not coupled or attached to the light-shielding portions 110 and 120 in the remaining region in the width direction of the first and second light-shielding portions 110 and 120.

With this configuration, as illustrated in FIG. 12A or FIG. 13, when the light-transmitting portion 130 is coupled between the first light-shielding portion 110 and the second light-shielding portion 120, in case that the light-transmitting portion 130 is attached or coupled to the light-shielding portions 110 and 120 from the position exceeding half the width of each of the light-shielding portions 110 and 120 to the outer edge each of the light-shielding portions 110 and 120, i.e., in case that the region 152 in which the light-transmitting portion 130 is attached or coupled to each of the light-shielding portions 110 and 120 accounts for less than 50% of the width of each of the light-shielding portions 110 and 120, a long distance (L2 in (b) of FIG. 12) from a bonding point to a central portion of the light-transmitting portion 130 may be ensured in comparison with a case in which a position at which the light-transmitting portion 130 begins to be coupled or attached to the light-shielding portions 110 and 120 is a position of half or less the width of each of the light-shielding portions 110 and 120, as illustrated in FIG. 11. That is, as illustrated in (b) of FIG. 12A, the sufficient distance L2 from the bonding line 150 to the central portion of the light-transmitting portion 130 may be ensured.

FIG. 12B is a partially enlarged view illustrating the attachment or coupling configuration of the light-transmitting portion to the light-shielding portion in the light-shielding fabric in FIG. 12A. And FIG. 12C is a view schematically illustrating a state in which the two light-shielding portions are arranged at a predetermined interval in parallel with each other in the light-shielding fabric in FIG. 12A when viewed from above. And FIG. 12D is a view schematically illustrating a state in which the light-shielding fabrics in FIG. 12C are arranged to be adjacent to one another and fixed when viewed from above. For example, as illustrated in FIG. 12B, a bonding agent 151 for bonding the light-transmitting portion 130 to the light-shielding portions 120 and 130 is present only in the bonding region 152 of less than 50% of the width of each of the light-shielding portions 110 and 120. Accordingly, when using the curtain-type vertical blind 100 made of the light-shielding fabric according to the embodiment of the present disclosure, in case that the two light-shielding portions are adjusted to be disposed at a predetermined interval in parallel with each other as illustrated in FIG. 12C, the light-transmitting portion 130 may be freely separated from the outer surfaces of the light-shielding portions 110 and 120 in the region in which the bonding agent 151 is not applied. Therefore, even though the light-transmitting portion 130 is curved in a U shape, the light-transmitting portions 130 are naturally spaced apart from each other, and stiffness decreases. Therefore, as illustrated in FIG. 12D, when the light-shielding fabrics are arranged to be adjacent to each other, the adjacent light-transmitting portions come into contact with each other, such that a gap is not formed between the adjacent light-transmitting portions.

According to the above-mentioned configuration, even though the light-transmitting portion 130 positioned between the first light-shielding portion 110 and the second light-shielding portion 120 is curved in a U shape when the curtain-type vertical blind 1 is folded, the distances L2 from the two opposite edges (bonding portions) to the central portion of the light-transmitting portion 130 are increased. Therefore, when the blind is folded, a radius of curvature increases, and the stiffness for maintaining the original shape of the light-transmitting portion 130 decreases. Therefore, as illustrated in FIG. 14, the first and second light-shielding portions 110 and 120 are not spaced apart from each other, and the state in which the light-shielding portions 110 and 120 are in close contact with each other may be maintained.

In the first and second embodiments of the present disclosure and the modified example thereof, the light-transmitting portion 130 and the first and second light-shielding portions 110 and 120 may be attached by heating and compressing hot-melt adhesive or the first and second light-shielding portions 110 and 120, and the light-transmitting portion may be attached by applying and compressing a woven fabric bonding agent. The first and second light-shielding portions 110 and 120 and the light-transmitting portion 130 may be attached by sewing or ultrasonic welding or attached or coupled by other known methods. A detailed description thereof will be omitted.

The curtain-type vertical blind according to the first and second embodiments of the present disclosure and the modified examples thereof may be manufactured by continuously coupling the adjacent light-shielding fabric sections.

Adjustment means (not illustrated) may be installed at one side of the upper guide rail 300, which guides a horizontal movement of the curtain-type vertical blind 100 according to the first and second embodiments of the present disclosure and the modified examples thereof, and adjust the horizontal movement of the curtain-type vertical blind and the leftward and rightward rotation angles with respect to the vertical axis of the blinds.

In addition, in the light-shielding fabric 1 of the curtain-type vertical blind 100 according to the first and second embodiments of the present disclosure and the modified examples thereof, counterweights (not illustrated) may be additionally at the lower end of the first light-shielding portion 110 and the lower end of the second light-shielding portion 120, and the counterweights may be attached to each other in a magnetic manner. In addition, base panels (not illustrated) may be additionally to the lower end of the first light-shielding portion 110 and the lower end of the second light-shielding portion 120 to further increase the weight. With this configuration, it is possible to uniformly stretch the blinds downward and prevent the lower ends of the blinds from being spaced apart from one another.

In the curtain-type vertical blind 100 according to the first and second embodiments of the present disclosure and the modified examples thereof, the rear surface 110b of the first light-shielding portion 110 of one section 10 among a plurality of light-shielding fabric sections (10, 20, 30, . . . , and n) and the rear surface 120b of the second light-shielding portion 120 of another section 20 are coupled to be in contact with each other, such that the front surface 110a of the first light-shielding portion 110 of one light-shielding fabric section 10 and the front surface 120a of the second light-shielding portion 120 of another light-shielding fabric section 20 become blind surfaces visible from the outside.

With this configuration, in the state in which the curtain-type vertical blind 100 is unfolded in the horizontal direction (the state in FIG. 21), when the first light-shielding portions 110 and the second light-shielding portions 120 of the plurality of light-shielding fabric sections (10, 20, 30, . . . , and n) are rotated about the vertical axis in one direction, the front surface 110a of the first light-shielding portions 110 may be exposed to the indoor side and define the blind surface with the first color A (hatched portion with large intervals) (the state in FIG. 22), and the second color B (hatched portion with narrow intervals) of the front surface 120a of the second light-shielding portions 120 may be exposed to the outdoor side.

On the contrary, when the first light-shielding portions 110 and the second light-shielding portions 120 of the plurality of light-shielding fabric sections (10, 20, 30, . . . , and n) are rotated about the vertical axis in a direction opposite to one direction, the front surface 120a of the second light-shielding portions 120 may be exposed to the indoor side and define the blind surface of the second color B (hatched portion with narrow intervals) (the state in FIG. 23), and the first color A (hatched portion with large intervals) of the front surface 110a of the first light-shielding portions 110 may be exposed to the outdoor side.

Therefore, in the curtain-type vertical blind 100 manufactured by using the light-shielding fabric for the curtain-type vertical blind 100 according to the present disclosure, one color (A or B) may be selected or implemented from the two colors (A and B) depending on the rotation directions of the light-shielding portions, such that various indoor appearances may be established, and disharmony or unpleasantness may not be caused to other persons. For example, in case that the first color A of the front surface 110a of the first light-shielding portion 110 is white and the second color B of the front surface 120a of the second light-shielding portion 120 is beige, the indoor side may be implemented with beige of the second color B to establish warm and calm indoor appearances, and the outdoor side may be implemented with white of the first color A to show bright window external appearances. In addition, in case that the first color A of the front surface 110a of the first light-shielding portion 110 is white and the second color B of the front surface 120a of the second light-shielding portion 120 is pink or sky-blue for consumers who prefer strongly individual colors, the indoor side may be implemented with pink or sky-blue of the second color B to establish unique indoor appearances, and the outdoor side may be implemented with white of the first color A to show bright window external appearances, such that the individuality of the consumer may be ensured, the overall views of the apartments may not be spoiled in the collective buildings such as the apartments, and disharmony or unpleasantness may not be caused to other persons.

Meanwhile, according to the modified example of the first and second embodiments of the present disclosure, the light-shielding fabric for a curtain-type vertical blind may include a single light-transmitting portion 130 capable of transmitting light, a first light-shielding portion 110 disposed at one side of the light-transmitting portion 130 and attached or coupled to the light-transmitting portion, and a second light-shielding portion 120 disposed at the other side of the light-transmitting portion 130 and attached or coupled to the light-transmitting portion; in which the light-transmitting portion 130 may be disposed to cover the entire front or rear surfaces of the first and second light-shielding portions 110 and 120, and the light-transmitting portion 130 may be attached or coupled to the first and second light-shielding portions 110 and 120 from the point exceeding half the width of the front or rear surface of each of the first and second light-shielding portions 110 and 120 to the outer edge of each of the first and second light-shielding portions 110 and 120; and in which the front surface 110a of the first light-shielding portion 110, the rear surface 110b of the first light-shielding portion 110, the front surface 120a of the second light-shielding portion 120, and the rear surface 120b of the second light-shielding portion 120 may have the same color.

In the light-shielding fabric for a curtain-type vertical blind according to the modified example of the first and second embodiments, the bonding agent 151, which bonds the light-transmitting portion 130 to the light-shielding portions 110 and 120, is present only in the bonding region 152 of less than 50% of the width of each of the light-shielding portions 110 and 120. Accordingly, when the two light-shielding portions are adjusted to be disposed at a predetermined interval in parallel with each other by using the curtain-type vertical blind 100 manufactured by using the light-shielding fabric according to the modified example of the first and second embodiments, the light-transmitting portion 130 may be freely separated from the outer surfaces of the light-shielding portions 110 and 120 in the region in which the bonding agent 151 is not applied. Therefore, even though the light-transmitting portion 130 is curved in a U shape, the light-transmitting portions 130 are naturally spaced apart from each other, and stiffness decreases. Therefore, when the light-shielding fabrics are arranged to be adjacent to each other, the adjacent light-transmitting portions come into contact with each other, such that a gap is not formed between the light-transmitting portions.

### Third Embodiment

Next, a light-shielding fabric 1 for a curtain-type vertical blind 100 according to a third embodiment of the present disclosure will be described. In the description of the light-shielding fabric 1 according to the third embodiment, descriptions of the parts similar in configurations and operations to the parts of the light-shielding fabric 1 according to the first and second embodiments and the modified examples thereof will be omitted.

In the first and second embodiments of the present disclosure and the modified examples thereof, the front and rear surfaces of the first light-shielding portion 110 and the second light-shielding portion 110 of the light-shielding fabric 1 have the first color A and/or the second color B. In contrast, the third embodiment and the modified example thereof differ from the first and second embodiments of the present disclosure and the modified example thereof in that a light reflective layer is formed on the front surface of the first light-shielding portion 110 of the light-shielding fabric 1, and a light absorption layer is formed on the front surface of the second light-shielding portion 120.

The third embodiment and the modified example thereof of the present disclosure will be described with reference to FIGS. 8A to 9C.

In FIG. 8A, (a) is a view illustrating the front surface of the light-shielding fabric 1 for the curtain-type vertical blind 100 of the present disclosure, and (b) is a view illustrating the rear surface of the light-shielding fabric 1 for the curtain-type vertical blind of the present disclosure.

As illustrated in (a) and (b) of FIG. 8A, the light-shielding fabric 1 for the curtain-type vertical blind 100 according to the third embodiment of the present disclosure includes a single light-transmitting portion 130 capable of transmitting light, a first light-shielding portion 110 disposed at one side of the light-transmitting portion 130 and attached or coupled to the light-transmitting portion, and a second light-shielding portion 120 disposed at the other side of the light-transmitting portion 130 and attached or coupled to the light-transmitting portion. The light reflective layer may be formed on the front surface 110a (hatched portion with large intervals) of the first light-shielding portion 110 illustrated in (a) of FIG. 8A, and the light absorption layer may be formed on the front surface 120a (hatched portion with narrow intervals) of the second light-shielding portion 120. For example, the light reflective layer may have a smoother surface as the amount of specularly reflected light increases, and the light absorption layer may be formed to have a relatively rougher surface than the light reflective layer.

In addition, for example, according to the modified example of the third embodiment of the present disclosure, as illustrated in (b) of FIG. 9A, (b) of FIG. 9B, and (b) of FIG. 9C, the light-transmitting portion 130 may be arranged to cover the entire front or rear surfaces of the first light-shielding portion 110 and the second light-shielding portion 120. That is, the first light-shielding portion 110 and the second light-shielding portion 120 may be disposed at a predetermined interval at one side and the other side of the single light-transmitting portion 130, respectively.

In addition, according to the modified example of the third embodiment of the present disclosure, the separate second light-shielding portion 120 and the separate first light-shielding portion 10 may be additionally attached and coupled to the inner or outer surfaces of the second light-shielding portion 120 and the first light-shielding portion 110 at leftmost and rightmost sides of the curtain-type vertical blind 100.

Meanwhile, the light-shielding fabric 1 for the curtain-type vertical blind 100 according to the modified example of the third embodiment may include a single light-transmitting portion 130 capable of transmitting light, a first light-shielding portion 110 disposed at one side of the light-transmitting portion 130 and attached or coupled to the light-transmitting portion, and a second light-shielding portion 120 disposed at the other side of the light-transmitting portion 130 and attached or coupled to the light-transmitting portion. The first light-shielding portion 110 may be made of a material that reflects light well, and the second light-shielding portion 120 may be made of a material that absorbs light well. The material capable of reflecting light well or the material capable of absorbing light well may use a known technology, and a detailed description thereof will be omitted.

In the curtain-type vertical blind 100 according to the third embodiment of the present disclosure and the modified example thereof, the rear surface 110b of the first light-shielding portion 110 of one section 10 and the rear surface 120b of the second light-shielding portion 120 of another section 20 among a plurality of light-shielding fabric sections (10, 20, 30, . . . , and n) are coupled to be in contact with each other, such that the front surface 110a of the first light-shielding portion 110 of one light-shielding fabric section 10 and the front surface 120a of the second light-shielding portion 120 of another light-shielding fabric section 20 become blind surfaces visible from the outside. In this case, the light reflective layer may be formed on the front surface 110a of the first light-shielding portions 110, and the light absorption layer may be formed on the front surface 120a of the second light-shielding portions 120.

With this configuration, in the state in which the curtain-type vertical blind 100 is unfolded (the state in FIG. 21), when the first light-shielding portions 110 and the second light-shielding portions 120 of the plurality of light-shielding fabric sections (10, 20, 30, . . . , and n) are rotated about the vertical axis in one direction, the front surface 110a (hatched portion with large intervals) of the first light-shielding portions 110 may be exposed to the indoor side such that the light reflective layer or a light reflective material member defines a blind surface (the state in FIG. 22), and the light absorption layer or a light absorption material member of the front surface 120a (hatched portion with narrow intervals) of the second light-shielding portions 120 may be exposed to the outdoor side.

On the contrary, when the first light-shielding portions 110 and the second light-shielding portions 120 of the plurality of light-shielding fabric sections (10, 20, 30, . . . , and n) are rotated about the vertical axis in the direction opposite to one direction, the front surface 120a (the hatched portion with small intervals) of the second light-shielding portions 120 may be exposed to the indoor side such that the light absorption layer or the light absorption material member defines the blind surface (the state in FIG. 23), and the light reflective layer or the light reflective material member of the front surface 110a (the hatched portion with wide intervals) of the first light-shielding portions 110 may be exposed to the outdoor side.

Therefore, in the curtain-type vertical blind 100 manufactured by using the light-shielding fabric for the curtain-type vertical blind 100 according to the present disclosure, one function may be selected and implemented from the two functions (the light reflection function and the light absorption function) depending on the rotation direction of the light-shielding portion, such that the solar heat transfer properties may be adjusted for each season.

For example, in case that the front surface 110a of the first light-shielding portion 110 is configured as the light reflective layer or the first light-shielding portion 110 is made of a light reflective material and in case that the front surface 120a of the second light-shielding portion 120 is configured as the light absorption layer or the second light-shielding portion 120 is made of a light absorption material, the blind is adjusted in the summer season so that the front surface 110a (the light reflective layer or the light reflective material member) of the first light-shielding portion 110 is directed toward the outdoor side to reduce the amount of solar heat to be transferred to the interior and suppress an increase in indoor temperature, and the blind is adjusted in the winter season so that the front surface 120a (the light absorption layer or the light absorption material member) of the second light-shielding portion 120 is directed toward the outdoor side to increase the amount of solar heat to be transferred to the interior and facilitate an increase in indoor temperature, such that the solar heat transfer properties may be adjusted for each season by using the single curtain-type vertical blind.

In addition, in the curtain-type vertical blind 100 manufactured by using the light-shielding fabric for the curtain-type vertical blind according to the modified example of the third embodiment of the present disclosure, one material may be selected and implemented from two types of materials depending on the rotation direction of the light-shielding portion, such that different indoor appearances may be implemented depending on the texture of the material.

The method of attaching the light-transmitting portion and the light-shielding portion in the light-shielding fabric for the curtain-type vertical blind according to the third embodiment of the present disclosure and the modified example thereof may be applied in the same way as the method of attaching the light-transmitting portion and the light-shielding portion in the first and second embodiments and the modified examples thereof.

In addition, in case that the curtain-type vertical blind is manufactured by using the light-shielding fabric for a curtain-type vertical blind according to the third embodiment of the present disclosure and the modified example thereof, the counterweights installed at the lower ends of the first and second light-shielding portions of the light-shielding fabric 1 may be equally applied to the third embodiment and the modified examples thereof.

### Fourth Embodiment

Next, a fourth embodiment related to a method of manufacturing the curtain-type vertical blind 100 according to the first and second embodiments of the present disclosure and the modified examples thereof will be described with reference to FIGS. 15 and 19. First, the light-shielding fabric 1 according to the first and second embodiments of the present disclosure and the modified examples thereof is cut into a plurality of light-shielding fabric sections (10, 20, 30, 40, 50, 60, . . . , and n) having a predetermined length (a length corresponding to a vertical height of a window or doorway). The adjacent light-shielding fabric sections (10, 20, 30, 40, 50, 60, . . . , and n) are disposed by arranging the plurality of light-shielding fabric sections (10, 20, 30, 40, 50, 60, . . . , and n), which is cut as described above, so that the rear surface 110b of the first light-shielding portion 110 of one section 10 and the rear surface 120b of the second light-shielding portion 120 of another section 20 are in contact with each other. Among the plurality of light-shielding fabric sections (10, 20, 30, . . . , and n) disposed as described above, the upper end of the first light-shielding portion 110 of one section 10 and the upper end of the second light-shielding portion 120 of another section 20 are fixed together by fixing means 200, such that the adjacent light-shielding fabric sections (10, 20, 30, 40, 50, 60, . . . , and n) are fixed.

As illustrated in FIGS. 15, 17, and 19, in the method of manufacturing the curtain-type vertical blind 100 according to the fourth embodiment of the present disclosure, since the adjacent light-shielding fabric sections (10, 20, 30, 40, 50, 60, . . . , and n) are fixed together, the light-shielding portions 110 and 120 in the adjacent light-shielding fabric sections overlap at centers thereof, but only the first light-shielding portion 110 or the second light-shielding portion 120 is disposed at the outermost sides of the left and right sides. Therefore, the amount of transmission of the light passing through the light-shielding portions 110 and 120 at the center thereof is different from the amount of transmission of the light passing through the first light-shielding portion 110 or the second light-shielding portion 120 at the leftmost and rightmost sides, which may cause a situation in which the above-mentioned transmission of light in the blinds is non-uniform in accordance with the positions. In order to prevent this situation, in the method of manufacturing the curtain-type vertical blind 100 according to the modified example of the fourth embodiment of the present disclosure, the separate second light-shielding portion 120 and the separate first light-shielding portion 10 may be additionally attached and coupled to the inner or outer surfaces of the second light-shielding portion 120 and the first light-shielding portion 110 at leftmost and rightmost sides of the curtain-type vertical blind 100. FIG. 16 illustrates that the separate second light-shielding portion 120 and the separate first light-shielding portion 10 are additionally attached and coupled to the inner surfaces of the second light-shielding portion 120 and the first light-shielding portion 110 at leftmost and rightmost sides of the curtain-type vertical blind 100.

In addition, the upper end of the first light-shielding portion 110 and the upper end of the second light-shielding portion 120 of the adjacent light-shielding fabric sections (10, 20, 30, 40, 50, 60, . . . , and n) may be fixed by various methods.

For example, one or more through-holes 160 are formed, by using an awl or a punching machine, at the upper end of the first light-shielding portion 110 and the upper end of the second light-shielding portion 120 of the light-shielding fabric sections. Next, in the state in which the upper end of the first light-shielding portion 110 and the upper end of the second light-shielding portion 120 are disposed to be in contact with each other, a fixing pin 210 of the detachable fixing means 200 may be fixedly inserted into a fixing hole 230 to couple the first light-shielding portion 110 and the second light-shielding portion 120. FIGS. 17A and 17B illustrate examples of the fixing means 200 that may be used to manufacture the curtain-type vertical blind according to the first and second embodiments of the present disclosure and the modified example thereof. A coupling groove 220, which may be detachably coupled to an upper guide rail 300, may be formed at an upper end of the fixing means 200. The method of coupling the fixing means 200 of the first and second light-shielding portions 110 and 120 to the upper guide rail 300 may use a known technology, and a member in the form of a ring or clip may be used as the fixing means.

In addition, for example, a coupling member, such as a detachable Velcro tape, may be additionally installed so that the lower end of the first light-shielding portion 110 and the lower end of the second light-shielding portion 120 of the adjacent light-shielding fabric sections (10, 20, 30, . . . , and n) are coupled to each other. The counterweights (not illustrated) may be additionally installed at the lower end of the first light-shielding portion 110 and the lower end of the second light-shielding portion 120 of the light-shielding fabric sections (10, 20, 30, . . . , and n), and the counterweights may be magnetically attached to each other. In addition, base panels (not illustrated) may be additionally to the lower end of the first light-shielding portion 110 and the lower end of the second light-shielding portion 120 to further increase the weight. With this configuration, it is possible to uniformly stretch the blinds downward and prevent the lower ends of the blinds from being spaced apart from one another.

Like the curtain-type vertical blind 100 according to the first and second embodiments and the modified examples thereof, the curtain-type vertical blind 100 according to the third embodiment of the present disclosure and the modified example thereof may also be manufactured by continuously coupling the light-shielding fabric sections, and the manufacturing process may be equally applied. Therefore, a detailed description thereof will be omitted.

### Fifth Embodiment

Next, the light-shielding fabric 1 for the curtain-type vertical blind 100 according to the fifth embodiment of the present disclosure will be described with reference to FIGS. 24 to 32. In the description of the light-shielding fabric 1 according to the fifth embodiment, descriptions of the parts similar in configurations and operations to the parts of the light-shielding fabric 1 according to the first and second embodiments and the modified example thereof will be omitted.

The fifth embodiment of the present disclosure is similar to the first and second embodiments and the modified examples thereof in that colors of the front and rear surfaces of the first light-shielding portion and the second light-shielding portion of the light-shielding fabric 1 are the first color A and/or the second color B. However, the fifth embodiment of the present disclosure differs from the first and second embodiments and the modified examples thereof in that a first magnet M1 is installed on the first light-shielding portion 110, and a second magnet or magnetic material M2 is installed on the second light-shielding portion 120.

In the light-shielding fabric 1 according to the fifth embodiment using the light-shielding fabric 1 for a curtain-type vertical blind in which the first light-shielding portion 110 and the second light-shielding portion 120 are disposed at one side and the other side of the light-transmitting portion 130 of the present disclosure, the first magnet M1 may be installed on the first light-shielding portion 110, and the second magnet or magnetic material M2 may be installed on the second light-shielding portion 120. Here, “the magnetic material”, for example, includes materials that have a property of being attracted to a magnet, such as iron, cobalt, nickel, and alloys or compounds thereof. Even when a magnetic material M2 is installed on the second light-shielding portion 120 instead of the second magnet M2, the first magnet M1 installed on the first light-shielding portion 110 can attract the magnetic material M2 installed on the second light-shielding portion 120, so that the first light-shielding portion 110 and the second light-shielding portion 120 can be in close contact with each other.

For example, as illustrated in FIG. 24, in the light-shielding fabric 1 of the fifth embodiment in which the light-shielding portions 110 and 120 are respectively bonded or coupled to one side and the other side of the light-transmitting portion 130, the first magnet M1 and the second magnet M2 may be made by aligning or magnetizing magnet powder contained in resin applied onto the first light-shielding portion 110 and the second light-shielding portion 120. In this case, the resin may serve as a bonding agent including an adhesive material. In the first magnet M1, the same polarities of magnet powder 114 contained in resin 113 applied onto the first light-shielding portion 110 may be aligned in the same direction. Preferably, the magnetic powder may be aligned or magnetized in a direction perpendicular to the surface of the light-shielding fabric 1. For example, a mixture of the magnet powder 114 and the resin 113, such as epoxy, polyethylene, polyurethane, polymethyl methacrylate (PMMA), or polyethylene terephthalate (PET) may be applied onto the first light-shielding portion 110 and aligned or magnetized. Both the magnet powder and the resin may be transparent or opaque, or a mixture of opaque magnet powder and transparent resin may be used. The same may be applied to the second magnet M2 installed on the second light-shielding portion 120. In this case, the resin and the magnet powder may be applied onto the rear surface 110b of the first light-shielding portion 110 and the rear surface 120b of the second light-shielding portion 120. In the embodiment illustrated in FIG. 24, the front surface 110a of the first light-shielding portion 110 and the rear surface 120b of the second light-shielding portion 120 have the first color A, and the rear surface 110b of the first light-shielding portion 110 and the front surface 120a of the second light-shielding portion 120 have the second color B.

In the light-shielding fabric 1 for the curtain-type vertical blind 100 according to the fifth embodiment of the present disclosure, the second magnet M2 installed on the second light-shielding portion 120 has the polarity opposite to the polarity of the first magnet M1 installed on the first light-shielding portion 110. For example, assuming that the first magnet M1 has an N-pole directed toward the front surface of the light-shielding fabric 1 and an S-pole directed toward the rear surface in a state in which the light-shielding fabric 1 is unfolded flat, the second magnet M2 may have an S-pole directed toward the front surface of the light-shielding fabric 1 and an N-pole directed toward the rear surface. As necessary, a colorant may be added to the transparent resin so that the colors of the first magnet M1 and the second magnet M2 may be colors desired by a user. In addition, as necessary, a colorant having the same color as the first and second light-shielding portions 110 and 120 may be added to the transparent resin, such that the first magnet M1 and the second magnet M2 may have the same color as the first and second light-shielding portions 110 and 120.

In addition, for example, as illustrated in FIG. 25, the light-shielding fabric may include a single light-transmitting portion 130 capable of transmitting light, a first light-shielding portion 110 disposed at one side of the light-transmitting portion 130 and attached or coupled to the light-transmitting portion, and a second light-shielding portion 120 disposed at the other side of the light-transmitting portion 130 and attached or coupled to the light-transmitting portion. In in the light-shielding fabric 1 in which the front surface 110a of the first light-shielding portion 110 and the rear surface 120b of the second light-shielding portion 120 have the first color A, the rear surface 110b of the first light-shielding portion 110 and the front surface 120a of the second light-shielding portion 120 have the second color B, the first magnet M1 and the second magnet M2 may be made by aligning or magnetizing the magnet powder contained in the resin applied onto the first light-shielding portion 110 and the second light-shielding portion 120. In FIG. 25, (a) illustrates the front surface of the light-shielding fabric 1, and (b) illustrates the rear surface of the light-shielding fabric 1. As illustrated in (b) of FIG. 25, the light-transmitting portion 130 may be arranged to cover the entire front or rear surfaces of the first light-shielding portion 110 and the second light-shielding portion 120. In this case, the resin may serve as a bonding agent including an adhesive material, and the resin may serve to bond the light-transmitting portion 130 to the first and second light-shielding portions 110 and 120.

In addition, for example, as illustrated in FIGS. 26 and 27, in the light-shielding fabric 1 in which the light-shielding portions 110 and 120 are respectively bonded or coupled to the two opposite edges of the light-transmitting portion 130, the first magnet M1 and the second magnet M2 may each be a film-type magnet made of a magnet material. FIG. 26 illustrates that the film-type magnets are respectively installed on the first light-shielding portion 110 and the second light-shielding portion 120 continuously in the upward/downward direction, and FIG. 27 illustrates that the film-type magnets are respectively installed on the first light-shielding portion 110 and the second light-shielding portion 120 at an interval in the upward/downward direction. FIGS. 26 and 27 illustrate that the film-type magnets are respectively arranged at the inner edges of the first light-shielding portion 110 and the second light-shielding portion 120. However, the film-type magnets may be respectively arranged at the outer edges or centers of the first light-shielding portion 110 and the second light-shielding portion 120. In this case, as necessary, the magnetic material may be installed on the second light-shielding portion 120 instead of the film-type second magnet M2.

In the embodiment in FIG. 26 or 27, in the light-shielding fabric 1 for a curtain-type vertical blind according to the present disclosure, for example, the first magnet M1 having a film shape may be installed on the rear surface of the first light-shielding portion 110 or the U-shaped curved inner surfaces of the light-transmitting portion 130 in the state in which the first light-shielding portion 110 is bonded to partially overlap one side edge of the light-transmitting portion 130. And the second magnet M2 having a film shape or the film-type magnetic material may be installed on the rear surface of the second light-shielding portion 120 or the U-shaped curved inner surfaces of the light-transmitting portion 130 in the state in which the second light-shielding portion 120 is bonded to partially overlap the other side edge of the light-transmitting portion 130. The bonding between the light-transmitting portion 130 and the first light-shielding portion 110 and the bonding between the light-transmitting portion 130 and the second light-shielding portion 120 may use the bonding agent or use ultrasonic or high-frequency welding. In this case, the magnetic material may be used as one of the first magnet M1 and the second magnet M2. As illustrated in FIG. 26, the first magnet M1 and the second magnet or magnetic material M2 may be continuously installed to be long in the longitudinal direction of the light-shielding fabric 1. As necessary, as illustrated in FIG. 27, the first magnet M1 and the second magnet or magnetic material M2 may be installed at an interval in the upward/downward direction and the longitudinal direction of the light-shielding fabric 1. In this case, the first and second magnets M1 and M2 may be installed on the front surfaces 110a and 120a or the rear surfaces 110b and 120b of the light-shielding fabric 1.

In addition, as necessary, in the embodiment in FIG. 26 or 27, in the light-shielding fabric 1 according to the present disclosure, for example, the first magnet M1 having a film shape may be inserted, joined, and coupled between the light-transmitting portion 130 and the first light-shielding portion 110 in the state in which the first light-shielding portion 110 partially overlaps one side edge of the light-transmitting portion 130. And the second magnet M2 having a film shape or the magnetic material having a film shape may be inserted, joined, and coupled between the light-transmitting portion 130 and the second light-shielding portion 120 in the state in which the second light-shielding portion 120 partially overlaps the other side edge of the light-transmitting portion 130.

In addition, for example, as illustrated in FIGS. 28 and 29, in the light-shielding fabric 1 of the fifth embodiment, the first magnet M1 and the second magnet M2 may be installed in circular shapes at the lower ends of the first light-shielding portion 110 and the second light-shielding portion 120, respectively. As described above, in case that the circular first magnet M1 and the circular second magnet M2 are attached to the lower end of the light-shielding fabric 1, the first magnet M1 and the second magnet M2 may serve as counterweights to sag and stretch the light-shielding fabric 1 of the blind downward. In this case, as illustrated in FIGS. 28 and 29, the first magnet M1 and the second magnet M2 may be installed to be biased toward the light-transmitting portion 130 in the front surface 110a of the first light-shielding portion 110 and the front surface 120a of the second light-shielding portion 120. In addition, the first magnet M1 and the second magnet or magnetic material M2 may be attached to the first light-shielding portion 110 and the second light-shielding portion 120 by fusion as a molten material is melted by ultrasonic or high-frequency waves in a state in which the first magnet M1 and the second magnet or magnetic material M2 are surrounded by or coated with the molten material that may be melted by ultrasonic or high-frequency waves.

In addition, for example, as illustrated in FIG. 30, in the light-shielding fabric 1 of the fifth embodiment, the first magnet M1 and the second magnet M2 may be installed in horizontal band shapes at the lower ends of the first light-shielding portion 110 and the second light-shielding portion 120, respectively.

In addition, in the modified example of the fifth embodiment, counterweights made of a metallic material may be installed, instead of the circular or band-shaped first and second magnets M1 and M2 respectively installed at the lower ends of the first light-shielding portion 110 and the second light-shielding portion 120 illustrated in FIGS. 28 to 30. In this case, the counterweight may also serve to sag and stretch the light-shielding fabric 1 of the blind downward. In addition, as illustrated in FIG. 30, a reinforcement portion 170 may be formed at the upper end of the light-shielding fabric 1 to couple the fixing means 200, and a through-hole 160 is formed in the reinforcement portion 170 to constitute the light-shielding fabric 1 according to the fifth embodiment of the present disclosure.

Next, for example, the vertical blind 100, which is manufactured by using the light-shielding fabric 1 for a curtain-type vertical blind according to the fifth embodiment of the present disclosure illustrated in FIGS. 24 to 30, will be described with reference to FIG. 32.

With reference to FIG. 32, the vertical blind 100 according to the present disclosure includes an upper guide rail 300 horizontally installed on a window frame, a wall surface of the window frame, or a ceiling, a plurality of runners (not illustrated) installed on the upper guide rail 300 and configured to be movable leftward and rightward, a plurality of fixing means 200 installed on the plurality of runners and configured to hold the upper ends of the second light-shielding portion 120 of the light-shielding fabric 1 adjacent to the first light-shielding portion 110 of the light-shielding fabric 1, and the plurality of light-shielding fabrics 1 according to the present disclosure coupled to the fixing means 200. In addition, adjustment means (not illustrated) or the like may be installed to move the runners to one side and rotate the light-shielding fabrics 1. However, because the adjustment means are known technologies, the illustration and description of the adjustment means will be omitted.

According to the light-shielding fabric 1 for a curtain-type vertical blind and the vertical blind 100 manufactured by using the same according to the fifth embodiment of the present disclosure and the modified example thereof described above, in the state in which the light-transmitting portion 130 is unfolded so that the front surface thereof is widely exposed, the first magnet M1, which is installed on the first light-shielding portion 110, and the second magnet or magnetic material M2, which is installed on the second light-shielding portion 120 of the adjacent light-shielding fabric 1, may attract and tightly attach the first light-shielding portion 110 and the second light-shielding portion 120, which is adjacent to each other, and minimize a degree to which the first light-shielding portion 110 and the second light-shielding portion 120 are spaced apart from each other, such that the contact between the adjacent light-shielding portions is remarkably improved, and the interior is not visible from the outside when the blind is closed. In addition, when the curtain-type vertical blind is manufactured by using the light-shielding fabric for a curtain-type vertical blind according to the fifth embodiment of the present disclosure, the contact between the adjacent light-shielding portions may be remarkably improved, thereby preventing light from being transmitted between the light-shielding portions or preventing a gap from being formed between the light-shielding portions in the state in which the blind is unfolded widely. In addition, when the curtain-type vertical blind is manufactured by using the light-shielding fabric for a curtain-type vertical blind according to the fifth embodiment of the present disclosure, the magnet installed at the lower end of the light-shielding fabric serves as a counterweight for sagging and unfolding the light-shielding fabric downward, such that the light-shielding fabrics do not blow away in the wind and thus are not misaligned. Further, the lower ends of the light-shielding fabrics are tightly attached to one another by magnetic forces, such that the light-shielding fabrics may be easily restored to original states and aligned even though the light-shielding fabrics are misaligned.

### Sixth Embodiment

Next, the light-shielding fabric 1 for the curtain-type vertical blind 100 according to the sixth embodiment of the present disclosure will be described with reference to FIGS. 33 to 37. In the description of the light-shielding fabric 1 according to the sixth embodiment, descriptions of the parts similar in configurations and operations to the parts of the light-shielding fabric 1 according to the first, second, and fifth embodiments and the modified examples thereof will be omitted.

The sixth embodiment of the present disclosure differs from the first and second embodiments in that the first magnet M1 is installed on the first light-shielding portion 110, and the second magnet or magnetic material M2 is installed on the second light-shielding portion 120. In addition, the sixth embodiment differs from the fifth embodiment in that all the front surfaces 110a and 120a and the rear surfaces 110b and 120b of the first light-shielding portion 110 and the second light-shielding portion 120 have the same color.

According to the sixth embodiment of the present disclosure, the light-shielding fabric 1 for a curtain-type vertical blind includes a single light-transmitting portion 130 capable of transmitting light, a first light-shielding portion 110 disposed at one side of the light-transmitting portion 130 and attached or coupled to the light-transmitting portion, and a second light-shielding portion 120 disposed at the other side of the light-transmitting portion 130 and attached or coupled to the light-transmitting portion, in which a first magnet M1 may be installed on the first light-shielding portion 110, and a second magnet M1 or the magnetic material may be installed on the second light-shielding portion 120.

For example, as illustrated in FIG. 33, in the light-shielding fabric 1 for a curtain-type vertical blind according to the sixth embodiment, the first magnet M1 and the second magnet M2 may be made by aligning or magnetizing the magnet powder contained in the resin applied onto the first light-shielding portion 110 and the second light-shielding portion 120. In this case, the resin may serve as a bonding agent containing an adhesive component.

In addition, for example, as illustrated in FIGS. 34 and 35, in the light-shielding fabric 1 for a curtain-type vertical blind according to the sixth embodiment, the first magnet M1 and the second magnet M2 may each be a film-type magnet made of a magnet material. FIG. 34 illustrates that the film-type magnets are respectively installed on the first light-shielding portion 110 and the second light-shielding portion 120 and installed continuously in the upward/downward direction, and FIG. 35 illustrates that the film-type magnets are respectively installed on the first light-shielding portion 110 and the second light-shielding portion 120 and installed at an interval in the upward/downward direction. FIGS. 34 and 35 illustrate that the film-type magnets are respectively arranged at the inner edges of the first light-shielding portion 110 and the second light-shielding portion 120. However, the film-type magnets may be arranged at the outer edges or centers of the first light-shielding portion 110 and the second light-shielding portion 120, respectively. In this case, as necessary, the magnetic material may be installed on the second light-shielding portion 120 instead of the film-type second magnet M2.

In addition, for example, as illustrated in FIG. 36, in the light-shielding fabric 1 for a curtain-type vertical blind according to the sixth embodiment, the first magnet M1 and the second magnet M2 may be installed in circular shapes at the lower ends of the first light-shielding portion 110 and the second light-shielding portion 120, respectively. As described above, in case that the circular first magnet M1 and the circular second magnet M2 are attached to the lower end of the light-shielding fabric 1, the first magnet M1 and the second magnet M2 may serve as counterweights to sag and stretch the light-shielding fabric 1 of the blind downward.

In addition, for example, as illustrated in FIG. 37, in the light-shielding fabric 1 for a curtain-type vertical blind according to the sixth embodiment, the first magnet M1 and the second magnet M2 may be installed in horizontal band shapes at the lower ends of the first light-shielding portion 110 and the second light-shielding portion 120, respectively.

In addition, in the modified example of the sixth embodiment, counterweights made of a metallic material may be installed, instead of the circular or band-shaped first and second magnets M1 and M2 respectively installed at the lower ends of the first light-shielding portion 110 and the second light-shielding portion 120 illustrated in FIGS. 36 an 37. In this case, the counterweight may also serve to sag and stretch the light-shielding fabric 1 of the blind downward.

Since the structure and operational effect of the vertical blind 100 manufactured by using the light-shielding fabric 1 for a curtain-type vertical blind according to the sixth embodiment of the present disclosure illustrated in FIGS. 33 to 37 are similar to those of the vertical blind 100 manufactured by using the light-shielding fabric 1 for a curtain-type vertical blind according to the fifth embodiment, a description thereof will be omitted.

While the present disclosure has been described with reference to the embodiment illustrated in the drawings, the embodiment is described just for illustration, and those skilled in the art to which the present disclosure pertains will understand that various modifications of the embodiment and any other embodiment equivalent thereto are available. Accordingly, the true technical protection scope of the present disclosure should be determined by the technical spirit of the appended claims.

What is claimed is:

1. A light-shielding fabric for a curtain-type vertical blind, the light-shielding fabric comprising:
a single light-transmitting portion (130) capable of transmitting light;
a first light-shielding portion (110) disposed at one side of the light-transmitting portion (130) and attached or coupled to the light-transmitting portion; and
a second light-shielding portion (120) disposed at the other side of the light-transmitting portion (130) and attached or coupled to the light-transmitting portion,
wherein a front surface (110a) of the first light-shielding portion (110) and a rear surface (120b) of the second light-shielding portion (120) have a first color (A),
wherein a rear surface (110b) of the first light-shielding portion (110) and a front surface (120a) of the second light-shielding portion (120) have a second color (B), and
wherein the first color (A) is different from the second color (B).

2. The light-shielding fabric of claim 1, wherein the light-transmitting portion (130) is arranged to cover the entire front or rear surfaces of the first light-shielding portion (110) and the second light-shielding portion (120).

3. A light-shielding fabric for a curtain-type vertical blind, the light-shielding fabric comprising:
a single light-transmitting portion (130) capable of transmitting light;
a first light-shielding portion (110) disposed at one side of the light-transmitting portion (130) and attached or coupled to the light-transmitting portion; and
a second light-shielding portion (120) disposed at the other side of the light-transmitting portion (130) and attached or coupled to the light-transmitting portion,
wherein a front surface (110a) of the first light-shielding portion (110) has a first color (A), and
wherein a front surface (120a) of the second light-shielding portion (120) has a second color (B) different from the first color (A).

4. The light-shielding fabric of claim 3, wherein the light-transmitting portion (130) is arranged to cover the entire front or rear surface of the first light-shielding portion (110) and the second light-shielding portion (120).

5. The light-shielding fabric of claim 4, wherein a rear surface (110b) of the first light-shielding portion (110) has the first color (A), and a rear surface (120b) of the second light-shielding portion (120) has the second color (B).

6. The light-shielding fabric of claim 4, wherein a rear surface (110b) of the first light-shielding portion (110) and a rear surface (120b) of the second light-shielding portion (120) have the same color.

7. The light-shielding fabric of claim 1, wherein a first magnet (M1) is installed on the first light-shielding portion (110), and a second magnet or magnetic material (M2) is installed on the second light-shielding portion (120).

8. The light-shielding fabric of claim 7, wherein the first magnet and the second magnet or magnetic material are configured by one or more of:
i) aligning or magnetizing magnet powder contained in resin applied onto the first light-shielding portion and the second light-shielding portion;
ii) installing the first magnet and the second magnet or magnetic material at lower ends of the first light-shielding portion and the second light-shielding portion, respectively;
iii) installing the first magnet and the second magnet or magnetic material on the first light-shielding portion and the second light-shielding portion, respectively, at an interval in an upward/downward direction; and
iv) installing the first magnet and the second magnet or magnetic material continuously in the upward/downward direction along the first light-shielding portion and the second light-shielding portion, respectively.

9. The light-shielding fabric of claim 3, wherein a first magnet (M1) is installed on the first light-shielding portion (110), and a second magnet or magnetic material (M2) is installed on the second light-shielding portion (120).

10. The light-shielding fabric of claim 9, wherein the first magnet and the second magnet or magnetic material are configured by one or more of:
i) aligning or magnetizing magnet powder contained in resin applied onto the first light-shielding portion and the second light-shielding portion;
ii) installing the first magnet and the second magnet or magnetic material at lower ends of the first light-shielding portion and the second light-shielding portion, respectively;
iii) installing the first magnet and the second magnet or magnetic material on the first light-shielding portion and the second light-shielding portion, respectively, at an interval in an upward/downward direction; and
iv) installing the first magnet and the second magnet or magnetic material continuously in the upward/downward direction along the first light-shielding portion and the second light-shielding portion, respectively.

11. The light-shielding fabric of claim 1, wherein counterweights are respectively installed at lower ends of the first light-shielding portion (110) and the second light-shielding portion (120).

12. The light-shielding fabric of claim 3, wherein counterweights are respectively installed at lower ends of the first light-shielding portion (110) and the second light-shielding portion (120).

13. A light-shielding fabric for a curtain-type vertical blind, the light-shielding fabric comprising:
a single light-transmitting portion (130) capable of transmitting light;
a first light-shielding portion (110) disposed at one side of the light-transmitting portion (130) and attached or coupled to the light-transmitting portion;
a second light-shielding portion (120) disposed at the other side of the light-transmitting portion (130) and attached or coupled to the light-transmitting portion;
a first magnet (M1) installed on the first light-shielding portion; and
a second magnet or magnetic material (M2) installed on the second light-shielding portion.

14. The light-shielding fabric of claim 13, wherein the light-transmitting portion (130) is arranged to cover the entire front or rear surface of the first light-shielding portion (110) and the second light-shielding portion (120).

15. The light-shielding fabric of claim 13, wherein the first magnet (M1) and the second magnet or magnetic material (M2) are configured by one or more of:
i) aligning or magnetizing magnet powder contained in resin applied onto the first light-shielding portion and the second light-shielding portion;
ii) installing the first magnet and the second magnet or magnetic material at lower ends of the first light-shielding portion and the second light-shielding portion, respectively;
iii) installing the first magnet and the second magnet or magnetic material on the first light-shielding portion and the second light-shielding portion, respectively, at an interval in an upward/downward direction; and
iv) installing the first magnet and the second magnet or magnetic material continuously in the upward/downward direction along the first light-shielding portion and the second light-shielding portion, respectively.

16. The light-shielding fabric of claim 1, wherein the light-transmitting portion (130) and the first and second light-shielding portions (110, 120) are integrally woven.

17. The light-shielding fabric of claim 3, wherein the light-transmitting portion (130) and the first and second light-shielding portions (110, 120) are integrally woven.

18. The light-shielding fabric of claim 1, wherein the light-transmitting portion (130) is attached or coupled to the first and second light-shielding portions (110, 120) from a point exceeding half a width of the front or rear surface of each of the first and second light-shielding portions (110, 120) to an outer edge of the first and second light-shielding portions (110, 120).

19. The light-shielding fabric of claim 1, wherein the first and second light-shielding portions (110, 120) and the light-transmitting portion (130) are attached or coupled by a hot-melt adhesive or a bonding agent.

20. The light-shielding fabric of claim 1, wherein the first and second light-shielding portions (110, 120) and the light-transmitting portion (130) are attached or coupled by sewing or ultrasonic welding.

21. The light-shielding fabric of claim 3, wherein the light-transmitting portion (130) is attached or coupled to the first and second light-shielding portions (110, 120) from a point exceeding half a width of the front or rear surface of each of the first and second light-shielding portions (110, 120) to an outer edge of the first and second light-shielding portions (110, 120).

22. The light-shielding fabric of claim 3, wherein the first and second light-shielding portions (110, 120) and the light-transmitting portion (130) are attached or coupled by a hot-melt adhesive or a bonding agent.

23. The light-shielding fabric of claim 3, wherein the first and second light-shielding portions (110, 120) and the light-transmitting portion (130) are attached or coupled by sewing or ultrasonic welding.

24. A light-shielding fabric for a curtain-type vertical blind, the light-shielding fabric comprising:
a single light-transmitting portion (130) capable of transmitting light;
a first light-shielding portion (110) disposed at one side of the light-transmitting portion (130) and attached or coupled to the light-transmitting portion; and
a second light-shielding portion (120) disposed at the other side of the light-transmitting portion (130) and attached or coupled to the light-transmitting portion,
wherein a light reflective layer is formed on a front surface (110a) of the first light-shielding portion (110), and a light absorption layer is formed on a front surface (120a) of the second light-shielding portion (120).

25. The light-shielding fabric of claim 24, wherein the light-transmitting portion (130) is arranged to cover the entire front or rear surface of the first light-shielding portion (110) and the second light-shielding portion (120).

26. The light-shielding fabric of claim 24, wherein the light-transmitting portion (130) and the first and second light-shielding portions (110, 120) are integrally woven.

27. The light-shielding fabric of claim 24, wherein a first magnet (M1) is installed on the first light-shielding portion (110), and a second magnet or magnetic material (M2) is installed on the second light-shielding portion (120).

28. The light-shielding fabric of claim 27, wherein the first magnet and the second magnet or magnetic material are configured by one or more of:
i) aligning or magnetizing magnet powder contained in resin applied onto the first light-shielding portion and the second light-shielding portion;
ii) installing the first magnet and the second magnet or magnetic material at lower ends of the first light-shielding portion and the second light-shielding portion, respectively;
iii) installing the first magnet and the second magnet or magnetic material on the first light-shielding portion and the second light-shielding portion, respectively, at an interval in an upward/downward direction; and
iv) installing the first magnet and the second magnet or magnetic material continuously in the upward/downward direction along the first light-shielding portion and the second light-shielding portion, respectively.

29. The light-shielding fabric of claim 24, wherein counterweights are respectively installed at lower ends of the first light-shielding portion (110) and the second light-shielding portion (120).

30. The light-shielding fabric of claim 24, wherein the light-transmitting portion (130) is attached or coupled to the first and second light-shielding portions (110, 120) from a point exceeding half a width of the front or rear surface of each of the first and second light-shielding portions (110, 120) to an outer edge of the first and second light-shielding portions (110, 120).

31. The light-shielding fabric of claim 24, wherein the first and second light-shielding portions (110, 120) and the light-transmitting portion (130) are attached or coupled by a hot-melt adhesive or a bonding agent.

32. The light-shielding fabric of claim 24, wherein the first and second light-shielding portions (110, 120) and the light-transmitting portion (130) are attached or coupled by sewing or ultrasonic welding.

33. A light-shielding fabric for a curtain-type vertical blind, the light-shielding fabric comprising:
a single light-transmitting portion (130) capable of transmitting light;
a first light-shielding portion (110) disposed at one side of the light-transmitting portion (130) and attached or coupled to the light-transmitting portion; and
a second light-shielding portion (120) disposed at the other side of the light-transmitting portion (130) and attached or coupled to the light-transmitting portion,
wherein the light-transmitting portion (130) is arranged to cover the entire front or rear surfaces of the first and second light-shielding portions (110, 120),
wherein the light-transmitting portion (130) is attached or coupled to the first and second light-shielding portions (110, 120) from a point exceeding half a width of the front or rear surface of each of the first and second light-shielding portions (110, 120) to an outer edge of each of the first and second light-shielding portions (110, 120), and
wherein a front surface (110a) of the first light-shielding portion (110), a rear surface (110b) of the first light-shielding portion (110), a front surface (120a) of the second light-shielding portion (120), and a rear surface (120b) of the second light-shielding portion (120) have the same color.

34. The light-shielding fabric of claim 33, wherein the first and second light-shielding portions (110, 120) and the light-transmitting portion (130) are attached or coupled by a hot-melt adhesive or a bonding agent.

35. The light-shielding fabric of claim 33, wherein the first and second light-shielding portions (110, 120) and the light-transmitting portion (130) are attached or coupled by sewing or ultrasonic welding.

36. A curtain-type vertical blind manufactured by the light-shielding fabric according to claim 1.

37. A curtain-type vertical blind manufactured by the light-shielding fabric according to claim 3.

38. A curtain-type vertical blind manufactured by the light-shielding fabric according to claim 24.

39. A curtain-type vertical blind comprising:
a rail;
a plurality of runners installed to be movable along the rail;
a plurality of light-shielding fabrics according to claim 7 curved in a U shape; and
a plurality of connectors respectively installed on the plurality of runners and configured to fix together the first light-shielding portions of the plurality of light-shielding fabrics and upper ends of the second light-shielding portions of the plurality of adjacent light-shielding fabrics,
wherein the first light-shielding portion and the second light-shielding portion disposed below the plurality of connectors are configured to be at least partially in contact with each other by a magnetic force.

40. A curtain-type vertical blind comprising:
a rail;
a plurality of runners installed to be movable along the rail;
a plurality of light-shielding fabrics according to claim 13 curved in a U shape; and
a plurality of connectors respectively installed on the plurality of runners and configured to fix together the first light-shielding portions of the plurality of light-shielding fabrics and upper ends of the second light-shielding portions of the plurality of adjacent light-shielding fabrics,
wherein the first light-shielding portion and the second light-shielding portion disposed below the plurality of connectors are configured to be at least partially in contact with each other by a magnetic force.

41. A method of manufacturing a curtain-type vertical blind by using the light-shielding fabric according to claim 1, the method comprising:
cutting the light-shielding fabric into a plurality of light-shielding fabrics sections (10, 20, 30, . . . , and n) having a predetermined length;
disposing the plurality of light-shielding fabrics sections (10, 20, 30, . . . , and n), which are cut in the cutting step, such that the adjacent light-shielding fabric sections (10, 20, 30, . . . , and n) are disposed so that the rear surface (110b) of the first light-shielding portion (110) of one section (10) and the rear surface (120b) of the second light-shielding portion (120) of another section (20) are in contact with each other; and
fixing the plurality of light-shielding fabrics sections (10, 20, 30, . . . , and n), which are disposed in the disposing step, such that the adjacent light-shielding fabric sections (10, 20, 30, . . . , n) are fixed so that an upper end of the first light-shielding portion (110) of one section (10) and an upper end of the second light-shielding portion (120) of another section (20) are fixed together,
wherein when the plurality of light-shielding fabrics sections (10, 20, 30, . . . , and n) are rotated in different directions, the front surface (110a) of the first light-shielding portion (110) of one section (10) and the front surface (120a) of the second light-shielding portion (120) of another section (20) of the plurality of light-shielding fabrics sections (10, 20, 30, . . . , and n) are blind surfaces visible from the outside, respectively.

42. The method of claim 41, wherein the separate light-shielding portions (110, 120) are additionally attached and disposed at outermost sides of left and right sides in the disposing step, respectively.

43. The method of claim 41, wherein in the fixing step, one or more through-holes (160) are formed at the upper end of the first light-shielding portion (110) of one section (10) and the upper end of the second light-shielding portion (120) of another section (20) of the plurality of light-shielding fabrics sections (10, 20, 30, . . . , n), and fixing means (200) are coupled to the through-holes (160), such that the upper end of the first light-shielding portion (110) of one section (10) and the upper end of the second light-shielding portion (120) of the another section (20) are fixed together.

44. A method of manufacturing a curtain-type vertical blind by using the light-shielding fabric according to claim 3, the method comprising:
cutting the light-shielding fabric into a plurality of light-shielding fabrics sections (10, 20, 30, . . . , and n) having a predetermined length;
disposing the plurality of light-shielding fabrics sections (10, 20, 30, . . . , and n), which are cut in the cutting step, such that the adjacent light-shielding fabric sections (10, 20, 30, . . . , and n) are disposed so that the rear surface (110b) of the first light-shielding portion (110) of one section (10) and the rear surface (120b) of the second light-shielding portion (120) of another section (20) are in contact with each other; and
fixing the plurality of light-shielding fabrics sections (10, 20, 30, . . . , and n), which are disposed in the disposing step, such that the adjacent light-shielding fabric sections (10, 20, 30, . . . , n) are fixed so that an upper end of the first light-shielding portion (110) of one section (10) and an upper end of the second light-shielding portion (120) of another section (20) are fixed together,
wherein when the plurality of light-shielding fabrics sections (10, 20, 30, . . . , and n) are rotated in different directions, the front surface (110a) of the first light-shielding portion (110) of one section (10) and the front surface (120a) of the second light-shielding portion (120) of another section (20) of the plurality of light-shielding fabrics sections (10, 20, 30, . . . , and n) are blind surfaces visible from the outside, respectively.

45. The method of claim 44, wherein the separate light-shielding portions (110, 120) are additionally attached and disposed at outermost sides of left and right sides in the disposing step, respectively.

46. The method of claim 44, wherein in the fixing step, one or more through-holes (160) are formed at the upper end of the first light-shielding portion (110) of one section (10) and the upper end of the second light-shielding portion (120) of another section (20) of the plurality of light-shielding fabrics sections (10, 20, 30, . . . , n), and fixing means (200) are coupled to the through-holes (160), such that the upper end of the first light-shielding portion (110) of one section (10) and the upper end of the second light-shielding portion (120) of the another section (20) are fixed together.

47. A curtain-type vertical blind manufactured by the method of claim 42, wherein when the first light-shielding portions (110) and the second light-shielding portions (120) of the plurality of light-shielding fabric sections (10, 20, 30, . . . , and n) are rotated about a vertical axis in one direction in a state in which the curtain-type vertical blind is unfolded, the front surface (110a) of the first light-shielding portions (110) is exposed to an outdoor side to define a blind surface having the first color (A), and
wherein when the first light-shielding portions (110) and the second light-shielding portions (120) are rotated in a direction opposite to one direction, the front surface (120a) of the second light-shielding portions (120) is exposed to the outdoor side to define a blind surface having the second color (B).

48. A curtain-type vertical blind manufactured by the method of claim 45, wherein when the first light-shielding portions (110) and the second light-shielding portions (120) of the plurality of light-shielding fabric sections (10, 20, 30, . . . , and n) are rotated about a vertical axis in one direction in a state in which the curtain-type vertical blind is unfolded, the front surface (110a) of the first light-shielding portions (110) is exposed to an outdoor side to define a blind surface having the first color (A), and
wherein when the first light-shielding portions (110) and the second light-shielding portions (120) are rotated in a direction opposite to one direction, the front surface (120a) of the second light-shielding portions (120) is exposed to the outdoor side to define a blind surface having the second color (B).

49. A curtain-type vertical blind manufactured by using the light-shielding fabric for a curtain-type vertical blind of claim 24 and by cutting the light-shielding fabric into a plurality of light-shielding fabrics sections (10, 20, 30, . . . , and n) having predetermined length, disposing the adjacent light-shielding fabric sections (10, 20, 30, . . . , and n) so that the rear surface (110b) of the first light-shielding portion (110) of one section (10) of the plurality of light-shielding fabrics sections (10, 20, 30, . . . , and n) and the rear surface (120b) of the second light-shielding portion (120) of another section (20) are in contact with each other, and then fixing together an upper end of the first light-shielding portion (110) of one section (10) and an upper end of the second light-shielding portion (120) of another section (20),
wherein when the first light-shielding portions (110) and the second light-shielding portions (120) of the plurality of light-shielding fabric sections (10, 20, 30, . . . , and n) are rotated about a vertical axis in one direction in a state in which the curtain-type vertical blind is unfolded, the front surface (110a) of the first light-shielding portions (110) is exposed to an outdoor side so that the light reflective layer defines a blind surface, and
wherein when the first light-shielding portions (110) and the second light-shielding portions (120) are rotated in a direction opposite to one direction, the front surface (120a) of the second light-shielding portions (120) is exposed to the outdoor side so that the light absorption layer defines a blind surface.

50. The curtain-type vertical blind of claim 49, wherein the separate light-shielding portions (110, 120) are additionally attached and disposed at outermost sides of left and right sides of the curtain-type vertical blind, respectively.
